(19) United States
(12) Patent Application Publication
(10) Pub. No.: US 2012/0019804 A1
(43) Pub. Date: Jan. 26, 2012

(54) CLEANING METHOD, CLEANING APPARATUS, DEVICE FABRICATING METHOD, PROGRAM, AND STORAGE MEDIUM

(75) Inventors: Ryo TANAKA, Saitama-shi (JP); Yutaka IKEDA, Kumagaya-shi (JP)

(73) Assignee: NIKON CORPORATION, Tokyo (JP)

(21) Appl. No.: 13/184,263

(22) Filed: Jul. 15, 2011

Related U.S. Application Data
(60) Provisional application No. 61/367,035, filed on Jul. 23, 2010.

(51) Int. Cl. G03B 27/52

(52) U.S. Cl. 355/77; 355/18

(57) ABSTRACT

A liquid immersion member cleaning method used in an immersion exposure apparatus exposes a substrate with exposure light that transits an exposure liquid, wherein the liquid immersion member is disposed at least partly around an optical member and an optical path of the exposure light, which passes through the exposure liquid between the optical member and the substrate. The cleaning method comprises: loading a cleaning tool into the immersion exposure apparatus and disposing the cleaning tool at a position at which it opposes a first recovery port of the liquid immersion member, which is capable of recovering the exposure liquid; and supplying a cleaning liquid to a recovery passageway of the liquid immersion member, wherethrough the exposure liquid from the first recovery port flows. The liquid immersion member has a first discharge port, which is for discharging the exposure liquid from the recovery passageway, and a second discharge port, which is for discharging a gas from the recovery passageway and hinders the discharge of the exposure liquid more than the first discharge port does; and the cleaning liquid is recovered from a recovery part of the cleaning tool via the first recovery port.

### CROSS-REFERENCE TO RELATED APPLICATION

This application is a non-provisional application claiming priority to and the benefit of U.S. Provisional Application No. 61/367,035, filed Jul. 23, 2010. The entire contents of which are incorporated herein by reference.

### BACKGROUND

1. Field of the Invention

The present invention relates to a cleaning method, a cleaning apparatus, a device fabricating method, a program, and a storage medium.

2. Description of Related Art

In the process of fabricating microdevices, such as semiconductor devices and electronic devices, using an immersion exposure apparatus that exposes a substrate with exposure light through an exposure liquid is known, as disclosed in, for example, U.S. Patent Application Publication No. 2008/0273181 and U.S. Patent Application Publication No. 2009/0195761.

### SUMMARY

In an immersion exposure apparatus, if a member that contacts the exposure liquid becomes contaminated, then, for example, exposure failures might occur and, as a result, defective devices might be produced. Consequently, it is preferable to satisfactorily clean any member that contacts the exposure liquid.

An object of aspects of the present invention is to provide a cleaning method and a cleaning apparatus that can satisfactorily clean, for example, a member that contacts an exposure liquid. Yet another object of aspects of the present invention is to provide a device fabricating method, a program, and a storage medium that can prevent defective devices from being produced.

A first aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid to a recovery passageway of the liquid immersion member, wherethrough the exposure liquid from the first recovery port flows; wherein, the liquid immersion member has a first discharge port, which is for discharging the exposure liquid from the recovery passageway, and a second discharge port, which is for discharging a gas from the recovery passageway and hinders the discharge of the exposure liquid more than the first discharge port does; and the cleaning liquid is recovered from a recovery part of the cleaning tool via the first recovery port.

A second aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid to a recovery passageway of the liquid immersion member, wherethrough the exposure liquid from the first recovery port flows; wherein, the liquid immersion member has a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and the cleaning liquid is recovered from a recovery part of the cleaning tool via the first recovery port.

A third aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid to a recovery passageway of the liquid immersion member, wherethrough the exposure liquid from the first recovery port flows; wherein, the liquid immersion member comprises a discharge part, which separately discharges the exposure liquid and a gas from the recovery passageway; the discharge part has a first discharge port, which is for discharging the exposure liquid from the recovery passageway, and a second discharge port, which is for discharging the gas from the recovery passageway; and the cleaning liquid is recovered from a recovery part of the cleaning tool via the first recovery port.

A fourth aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid from a supply part of the cleaning tool; wherein, the liquid immersion member has a first discharge port, which is for discharging the exposure liquid from the recovery passageway, and a second discharge port, which is for discharging a gas from the recovery passageway and hinders the discharge of the exposure liquid more than the first discharge port does; and the cleaning liquid supplied from the supply part of the cleaning tool is supplied to the recovery passageway via the first recovery port.

A fifth aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid from a supply part of the cleaning tool; wherein, the liquid immersion member has a first discharge port, which is for discharging from a recovery passageway a fluid that includes the exposure liquid and that has a higher percentage of the exposure liquid than of a gas, and a second discharge port, which is for discharging from the recovery passageway a fluid that includes the gas and that has a lower percentage of the exposure liquid than of the gas; and the cleaning liquid supplied from the supply part of the cleaning tool is supplied to the recovery passageway via the first recovery port.

A sixth aspect of the present invention provides a liquid immersion member cleaning method that is used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, and that comprises: loading a cleaning tool into the immersion exposure apparatus and disposing the cleaning tool at a position at which it opposes a first recovery port of the liquid immersion member, which is capable of recovering the exposure liquid; and supplying a cleaning liquid from a supply part of the cleaning tool; wherein, the liquid immersion member comprises a discharge part, which separately discharges the exposure liquid and a gas from the recovery passageway; and the cleaning liquid supplied from a supply part of the cleaning tool is supplied to the recovery passageway via the first recovery port.

A seventh aspect of the present invention provides a device fabricating method that comprises: cleaning at least part of the liquid immersion member using a cleaning method according to any one aspect of the first through sixth aspects; exposing the substrate via the exposure liquid; and developing the exposed substrate.

An eighth aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a recovery part, which is disposed at least partly in the cleaning tool and is capable of recovering a cleaning liquid; wherein, the liquid immersion member has a recovery passageway, wherethrough the exposure liquid from the first recovery port flows, a first discharge port, which is for discharging the exposure liquid from the recovery passageway, and a second discharge port, which is for discharging a gas from the recovery passageway and hinders the discharge of the exposure liquid more than the first discharge port does; and the recovery part recovers via the first recovery port the cleaning liquid supplied to the recovery passageway.

A ninth aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a recovery part, which is disposed at least partly in the cleaning tool and is capable of recovering a cleaning liquid; wherein, the liquid immersion member has a recovery passageway, wherethrough the exposure liquid from the first recovery port flows, a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and the recovery part recovers via the first recovery port the cleaning liquid supplied to the recovery passageway.

A tenth aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a recovery part, which is disposed at least partly in the cleaning tool and is capable of recovering a cleaning liquid; wherein, the liquid immersion member comprises a recovery passageway, wherethrough the exposure liquid from the first recovery port flows, and a discharge part, which separately discharges the exposure liquid and a gas from the recovery passageway; the discharge part has a first discharge port, which is for discharging the exposure liquid from the recovery passageway, and a second discharge port, which is for discharging the gas from the recovery passageway; and the recovery part recovers via the first recovery port the cleaning liquid supplied to the recovery passageway.

An eleventh aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a supply part, which is disposed at least partly in the cleaning tool and is capable of supplying a cleaning liquid; wherein, the liquid immersion member has a recovery passageway, wherethrough the exposure liquid from the first recovery port flows, a first discharge port, which is for discharging the exposure liquid from the recovery passageway, and a second discharge port, which is for discharging a gas from the recovery passageway and hinders the discharge of the exposure liquid more than the first discharge port does; and the supply part supplies the cleaning liquid to the recovery passageway via the first recovery port.

A twelfth aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a supply part, which is disposed at least partly in the cleaning tool and is capable of supplying a cleaning liquid; wherein, the liquid immersion member has a recovery passageway, wherethrough the exposure liquid from the first recovery port flows, a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and the supply part supplies the cleaning liquid to the recovery passageway via the first recovery port.

A thirteenth aspect of the present invention provides a cleaning apparatus of a liquid immersion member that is inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, and that comprises: a cleaning tool, which is capable of being loaded into and unloaded from the immersion exposure apparatus and is disposed at a position at which it opposes a first recovery port of the liquid immersion member, which is capable of recovering the exposure liquid; and a supply part, which is disposed at least partly in the cleaning tool and is capable of supplying a cleaning liquid; wherein, the liquid immersion member comprises a recovery passageway, wherethrough the exposure liquid from the first recovery port flows, and a discharge part, which separately discharges the exposure liquid and a gas from the recovery passageway; and the supply part supplies the cleaning liquid to the recovery passageway via the first recovery port.

A fourteenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, via a first discharge port, the exposure liquid in a recovery passageway of the liquid immersion member wherethrough the exposure liquid from the first recovery port flows; discharging a gas from the recovery passageway via a second discharge port, which hinders the discharge of the exposure liquid more than the first discharge port does; when an exposure is not being performed, loading a cleaning tool into the immersion exposure apparatus and disposing the cleaning tool at a position at which it opposes the first recovery port; supplying a cleaning liquid to the recovery passageway; and recovering the cleaning liquid from the recovery passageway via the first recovery port and then via a recovery part of the cleaning tool.

A fifteenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, from a recovery passageway of the liquid immersion member wherethrough the exposure liquid from the first recovery port flows, a fluid that includes the exposure liquid and that has a higher percentage of the exposure liquid than of the gas via a first discharge port; discharging from the recovery passageway a fluid that includes a gas and that has a lower percentage of the exposure liquid than of the gas via a second discharge port; when an exposure is not being performed, loading a cleaning tool into the immersion exposure apparatus and disposing the cleaning tool at a position at which it opposes the first recovery port; supplying a cleaning liquid to the recovery passageway; and recovering the cleaning liquid from the recovery passageway via the first recovery port and then via a recovery part of the cleaning tool.

A sixteenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, via a first discharge port of a discharge part that is capable of separately discharging the exposure liquid and a gas from a recovery passageway, the exposure liquid in the recovery passageway of the liquid immersion member wherethrough the exposure liquid from the first recovery port flows; discharging the gas from the recovery passageway via a second discharge port of the discharge part; when an exposure is not being performed, loading a cleaning tool into the immersion exposure apparatus and disposing the cleaning tool at a position at which it opposes the first recovery port; supplying a cleaning liquid to the recovery passageway; and recovering the cleaning liquid from the recovery passageway via the first recovery port and then via a recovery part of the cleaning tool.

A seventeenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, via a first discharge port, the exposure liquid in a recovery passageway of the liquid immersion member wherethrough the exposure liquid from the first recovery port flows; discharging a gas from the recovery passageway via a second discharge port, which hinders the discharge of the exposure liquid more than the first discharge port does; when an exposure is not being performed, loading a cleaning tool into the immersion exposure apparatus and disposing the cleaning tool at a position at which it opposes the first recovery port; supplying a cleaning liquid from a supply part of the cleaning tool; and supplying the cleaning liquid, which was supplied from the supply part, to the recovery passageway via the first recovery port.

An eighteenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, from a recovery passageway of the liquid immersion member wherethrough the exposure liquid from the first recovery port flows, a fluid that includes the exposure liquid and that has a higher percentage of the exposure liquid than of the gas via a first discharge port; discharging from the recovery passageway a fluid that includes a gas and that has a lower percentage of the exposure liquid than of the gas via a second discharge port; when an exposure is not being performed, loading a cleaning tool into the immersion exposure apparatus and disposing the cleaning tool at a position at which it opposes the first recovery port; supplying a cleaning liquid from a supply part of the cleaning tool; and supplying the cleaning liquid, which was supplied from the supply part, to the recovery passageway via the first recovery port.

A nineteenth aspect of the present invention provides a program that causes a computer to control an immersion exposure apparatus that exposes a substrate with exposure light that transits an exposure liquid and that comprises: forming an immersion space with the exposure liquid between a liquid immersion member and the substrate such that an optical path of the exposure light passing through the exposure liquid between an optical member and the substrate is filled with the exposure liquid; exposing the substrate with the exposure light, which transits the exposure liquid in the immersion space; recovering at least some of the exposure liquid from the space above the substrate via a first recovery port of the liquid immersion member; discharging, via a first discharge port of a discharge part that is capable of separately discharging the exposure liquid and a gas from a recovery passageway, the exposure liquid in the recovery passageway of the liquid immersion member wherethrough the exposure liquid from the first recovery port flows; discharging the gas from the recovery passageway via a second discharge port of the discharge part; when an exposure is not being performed, loading a cleaning tool into the immersion exposure apparatus and disposing the cleaning tool at a position at which it opposes the first recovery port; supplying a cleaning liquid from a supply part of the cleaning tool; and supplying the cleaning liquid, which was supplied from the supply part, to the recovery passageway via the first recovery port.

A twentieth aspect of the present invention provides a computer readable storage medium whereon a program according to any one aspect of the fourteenth through nineteenth aspects is stored.

According to the aspects of the present invention, any member that contacts an exposure liquid and the like can be cleaned satisfactorily. In addition, the present invention makes it possible to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 is a partial side cross sectional view of the liquid immersion member according to the first embodiment.

FIG. 4 is a schematic drawing for explaining one example of the operation of the liquid immersion member according to the first embodiment.

FIG. 5 is a schematic drawing for explaining one example of the operation of the liquid immersion member according to the first embodiment.

FIG. 6 is a flow chart for explaining one example of the operation of the exposure apparatus according to the first embodiment.

FIG. 7 is a diagram that shows one example of a cleaning apparatus according to the first embodiment.

FIG. 8 is a diagram that shows one example of the cleaning apparatus according to the first embodiment.

FIG. 9 is a flow chart for explaining one example of a cleaning sequence according to the first embodiment.

FIG. 10 is a diagram for explaining one example of the cleaning sequence according to the first embodiment.

FIG. 11 is a diagram for explaining one example of the cleaning sequence according to the first embodiment.

FIG. 12 is a side cross sectional view that shows one example of the liquid immersion member according to a second embodiment.

FIG. 13 is a flow chart for explaining one example of the cleaning sequence according to a third embodiment.

FIG. 14 is a diagram for explaining one example of the cleaning sequence according to the third embodiment.

FIG. 15 is a flow chart for explaining one example of a microdevice fabricating process.

FIG. 16 is a schematic drawing for explaining one example of the operation of discharging a liquid via a first discharge port according to the first embodiment.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

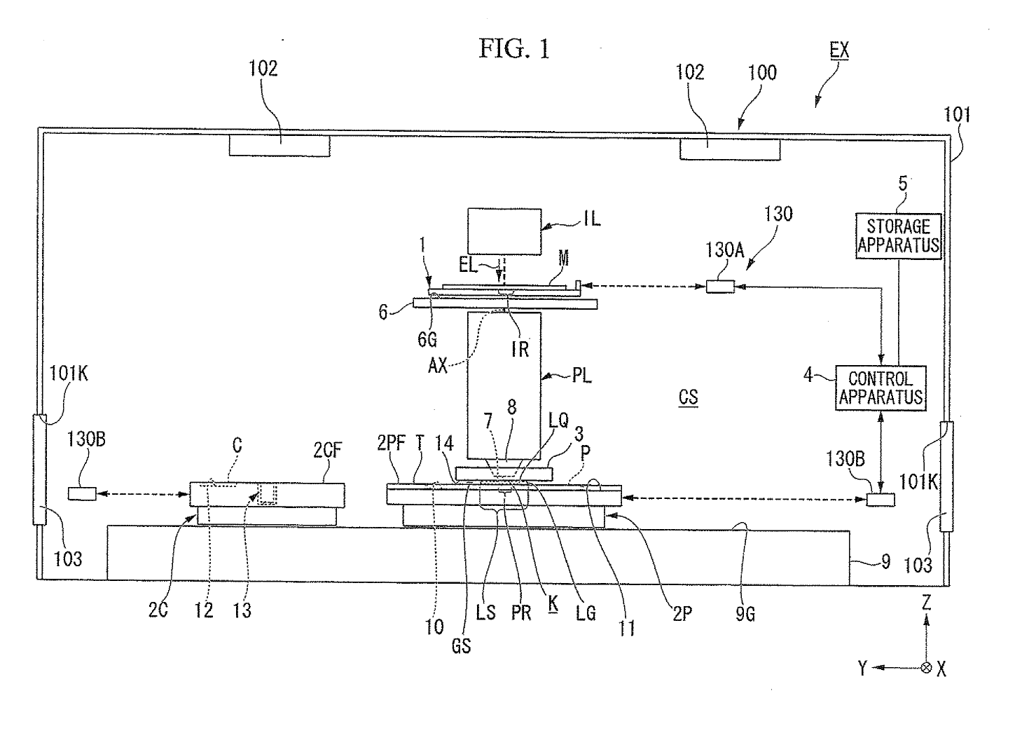

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that transits an exposure liquid LQ. In the present embodiment, an immersion space LS is formed so that at least part of an optical path K of the exposure light EL is filled with the exposure liquid LQ. The immersion space LS refers to a portion (i.e., a space or an area) that is filled with the liquid LQ. The substrate P is exposed with the exposure light EL, which transits the exposure liquid LQ in the immersion space LS. In the present embodiment, water (pure water) is used as the exposure liquid LQ.

In addition, the exposure apparatus EX of the present embodiment comprises a substrate stage and a measurement stage as disclosed in, for example, U.S. Pat. No. 6,897,963 and European Patent Application Publication No. 1713113.

In FIG. 1, the exposure apparatus EX comprises: a movable mask stage 1 that holds a mask M; a movable substrate stage 2P that holds the substrate P; a movable measurement stage 2C that does not hold the substrate P and whereon a measuring member C (i.e., a measuring instrument) that measures the exposure light EL is mounted; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space LS by holding the exposure liquid LQ between itself and the substrate P such that the optical path K of the exposure light EL radiated to the substrate P is filled with the exposure liquid LQ; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

In addition, the exposure apparatus EX comprises: a chamber member 101, which forms an internal space CS wherein at least the projection optical system PL, the liquid immersion member 3, the substrate stage 2P, and the measurement stage 2C are disposed; and a chamber apparatus 100 that comprises air conditioning apparatuses 102, which adjust the environment (i.e., the temperature, the humidity, the pressure, and the cleanliness level) of the internal space CS, and open-close mechanisms 103, which open and close openings 101K that are formed in the chamber member 101.

The mask M may be a reticle on which a device pattern to be projected to the substrate P is formed. The mask M may be a transmissive mask comprising a transparent plate, such as a glass plate, and the pattern, which is formed on the transparent plate using a shielding material, such as chrome. Furthermore, a reflective mask can also be used as the mask M.

The substrate P is a substrate for fabricating devices. The substrate P comprises, for example, a base material, such as a semiconductor wafer, and a photosensitive film, which is formed on the base material. The photosensitive film comprises a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 6G of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions along the guide surface 6G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 7 wherefrom the exposure light EL emerges and travels toward an image plane of the projection optical system PL. The emergent surface 7 belongs to a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In the present embodiment, the emergent surface 7 faces the −Z direction and is parallel to the XY plane. Furthermore, the emergent surface 7, which faces the −Z direction, may be a convex or a concave surface. The optical axis of the last optical element 8 is parallel to the Z axis. In the present embodiment, the exposure light EL that emerges from the emergent surface 7 proceeds in the −Z direction.

In the state wherein it holds the substrate P, the substrate stage 2P is capable of moving on a guide surface 9G of a base member 9, which includes the projection area PR. In the state wherein the measuring member C (i.e., the measuring instrument) is mounted thereon, the measurement stage 2C is capable of moving on the guide surface 9G of the base member 9, which includes the projection area PR. The substrate stage 2P and the measurement stage 2C each move by the operation of a drive system, which comprises a planar motor as disclosed in, for example, U.S. Pat. No. 6,452,292. Each planar motor comprises a slider, which is disposed on the corresponding stage, namely, the substrate stage 2P or the measurement stage 2C, and a stator, which is disposed on the base member 9. In the present embodiment, the substrate stage 2P and the measurement stage 2C are each capable of moving in six directions on the guide surface 9G, namely, the X axial, Y axial, Z axial, θX, θY, and θZ directions, by the operation of its corresponding drive system. Furthermore, the drive systems that move the substrate stage 2P and the measurement stage 2C do not have to comprise planar motors. For example, the drive systems may comprise linear motors.

The substrate stage 2P comprises a substrate holding part 10, which releasably holds the substrate P. In the present embodiment, the front surface (i.e., the upper surface) of the substrate P held by the substrate holding part 10 and an upper surface 2PF of the substrate stage 2P disposed around the substrate P are disposed within the same plane (i.e., they are flush with one another). The upper surface 2PF is flat. In the present embodiment, the front surface (i.e., the upper surface) of the substrate P, which is held by the substrate holding part 10, and the upper surface 2PF of the substrate stage 2P are substantially parallel to the XY plane.

Furthermore, the upper surface 2PF of the substrate stage 2P and the front surface (i.e., the upper surface) of the substrate P held by the substrate holding part 10 do not have to be disposed within the same plane; furthermore, the front surface of the substrate P or the upper surface 2PF, or both, may be nonparallel to the XY plane. In addition, the upper surface 2PF does not have to be flat. For example, the upper surface 2PF may include a curved surface.

In the present embodiment, the substrate stage 2P comprises a cover member holding part 11, which releasably holds a cover member T, as disclosed in, for example, U.S. Patent Application Publication No. 2007/0177125 and U.S. Patent Application Publication No. 2008/0049209. In the present embodiment, the upper surface 2PF of the substrate stage 2P includes an upper surface of the cover member T held by the cover member holding part 11.

Furthermore, the cover member T does not have to be releasable. In such a case, the cover member holding part 11 could be omitted. In addition, the upper surface 2PF of the substrate stage 2P may include the front surface of any sensor, measuring member, or the like installed on the substrate stage 2P.

The measurement stage 2C comprises a measuring member holding part 12, which releasably holds the measuring member C. In the present embodiment, the front surface (i.e., the upper surface) of the measuring member C held by the measuring member holding part 12 and an upper surface 2CF of the measurement stage 2C disposed around the measuring member C are disposed within the same plane (i.e., they are flush with one another). The upper surface 2CF is flat. In the present embodiment, the front surface (i.e., the upper surface) of the measuring member C held by the measuring member holding part 12 and the upper surface 2CF of the measurement stage 2C are substantially parallel to the XY plane.

In the present embodiment, the measuring member C installed on the measurement stage 2C may be a member that constitutes part of, for example, an aerial image measuring system as disclosed in U.S. Patent Application Publication No. 2002/0041377 and the like, a luminous flux intensity nonuniformity measuring system as disclosed in U.S. Pat. No. 4,465,368 and the like, a fiducial member as disclosed in U.S. Pat. No. 5,493,403 and the like, an irradiance measuring system as disclosed in U.S. Patent Application Publication No. 2002/0061469 and the like, or a wavefront aberration measuring system as disclosed in European Patent No. 1079223 and the like.

Furthermore, the front surface (i.e., the upper surface) of the measuring member C held by the measuring member holding part 12 and the upper surface 2CF of the measurement stage 2C do not have to be disposed within the same plane; furthermore, the front surface of the measuring member C or the upper surface 2CF, or both, may be nonparallel to the XY plane. In addition, the upper surface 2CF does not have to be flat. For example, the upper surface 2CF may include a curved surface. In addition, the measuring member C does not have to be releasable. In this case, the measuring member holding part 12 could be omitted.

In the present embodiment, the measurement stage 2C comprises an ultrasonic wave generating apparatus 13, which is capable of generating ultrasonic vibration, as disclosed in, for example, U.S. Patent Application Publication No. 2009/0251672. The ultrasonic wave generating apparatus 13 comprises a rod member and a piezoelectric device, which vibrates the rod member.

In the present embodiment, an interferometer system 130, which comprises laser interferometer units 130A, 130B, measures the positions of the mask stage 1, the substrate stage 2P, and the measurement stage 2C. The laser interferometer unit 130A is capable of measuring the position of the mask stage 1 using measurement mirrors, which are disposed on the mask stage 1. The laser interferometer unit 130B is capable of measuring the position of the substrate stage 2P using measurement mirrors, which are disposed on the substrate stage 2P. In addition, the laser interferometer unit 130B is capable of measuring the position of the measurement stage 2C using measurement mirrors, which are disposed on the measurement stage 2C. When an exposing process or a prescribed measurement process is performed on the substrate P, the control apparatus 4 controls, based on the measurement results of the interferometer system 130, the positions of the mask stage 1 (i.e., the mask M), the substrate stage 2P (i.e., the substrate P), or the measurement stage 2C (i.e., the measuring instrument C), or any combination thereof.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 radiates the exposure light EL to the substrate P through the projection optical system PL and the exposure liquid LQ in the immersion space LS above the substrate P while moving the substrate P in one of the Y axial directions with respect to the projection area PR of the projection optical system PL and moving the mask M, synchronized to the movement of the substrate P, in the other Y axial direction with respect to the illumination area IR of the illumination system IL.

The liquid immersion member 3 forms the immersion space LS such that the optical path K of the exposure light EL radiated to the projection area PR is filled with the exposure liquid LQ. The liquid immersion member 3 forms the immersion space LS by holding the exposure liquid LQ between itself and an object, which is disposed at a position to which the exposure light EL emerging from the emergent surface 7 of the last optical element 8 can be radiated, such that the optical path K of the exposure light EL between the last optical element 8 and the object is filled with the exposure liquid LQ.

In the present embodiment, the position whereto the exposure light EL emerging from the emergent surface 7 can be radiated includes the projection area PR. In addition, the position whereto the exposure light EL that emerges from the emergent surface 7 can be radiated includes the position at which the object opposes the emergent surface 7. In the present embodiment, the object that is capable of being disposed at the position at which the object opposes the emergent surface 7, in other words, the object that is capable of being disposed in the projection area PR, may be the substrate stage 2P (i.e., the cover member T), the substrate P held by the substrate stage 2P (i.e., the substrate holding part 10), or the measurement stage 2C (i.e., the measuring member C and the ultrasonic wave generating apparatus 13), or any combination thereof. In the exposure of the substrate P, the liquid immersion member 3 forms the immersion space LS by holding the exposure liquid LQ between itself and the substrate P such that the optical path K of the exposure light EL radiated to the substrate P is filled with the exposure liquid LQ.

In the present embodiment, the liquid immersion member 3 is disposed at least partly around the last optical element 8 and the optical path K of the exposure light EL that passes through the exposure liquid LQ between the last optical element 8 and the object disposed in the projection area PR. In the present embodiment, the liquid immersion member 3 is annular. In the present embodiment, part of the liquid immersion member 3 is disposed around the last optical element 8 and part of the liquid immersion member 3 is disposed around the optical path K of the exposure light EL between the last optical element 8 and the object. The immersion space LS is formed such that the optical path K of the exposure light EL between the last optical element 8 and the object disposed in the projection area PR is filled with the exposure liquid LQ.

Furthermore, the liquid immersion member 3 does not have to be annular. For example, the liquid immersion member 3 may be disposed partly around the last optical element 8 and the optical path K. In addition, the liquid immersion member 3 does not have to be disposed at least partly around the last optical element 8. For example, the liquid immersion member 3 may be disposed at least partly around the optical path K between the emergent surface 7 and the object and not around the last optical element 8. In addition, the liquid immersion member 3 does not have to be disposed at least partly around the optical path K between the emergent surface 7 and the object. For example, the liquid immersion member 3 may be disposed at least partly around the last optical element 8 and not around the optical path K between the emergent surface 7 and the object.

The liquid immersion member 3 has a lower surface 14, which the front surface (i.e., the upper surface) of the object disposed in the projection area PR is capable of opposing. The lower surface 14 of the liquid immersion member 3 can hold the exposure liquid LQ between itself and the front surface of the object. In the present embodiment, some of the exposure liquid LQ in the immersion space LS is held between the last optical element 8 and the object disposed such that the object opposes the emergent surface 7 of the last optical element 8. In addition, some of the exposure liquid LQ in the immersion space LS is held between the liquid immersion member 3 and the object disposed such that the object opposes the lower surface 14 of the liquid immersion member 3. Holding the exposure liquid LQ between the emergent surface 7 and the lower surface 14 on one side and the front surface (i.e., the upper surface) of the object on the other side forms the immersion space LS such that the optical path K of the exposure light EL between the last optical element 8 and the object is filled with the exposure liquid LQ.

In the present embodiment, when the substrate P is being irradiated with the exposure light EL, the immersion space LS is formed such that part of the area of the front surface of the substrate P that includes the projection area PR is covered with the exposure liquid LQ. At least part of an interface LG (i.e., a meniscus or edge) of the exposure liquid LQ is formed between the lower surface 14 of the liquid immersion member 3 and the front surface of the substrate P. Namely, the exposure apparatus EX of the present embodiment adopts a local liquid immersion system. The outer side of the immersion space LS (i.e., the outer side of the interface LG) is a gas space GS.

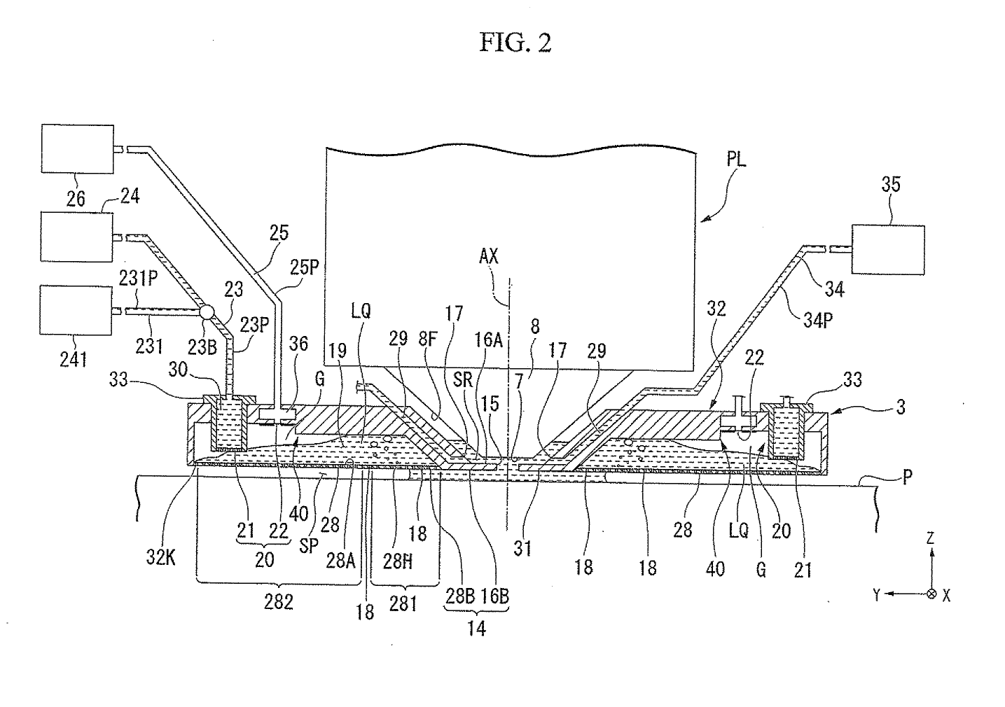

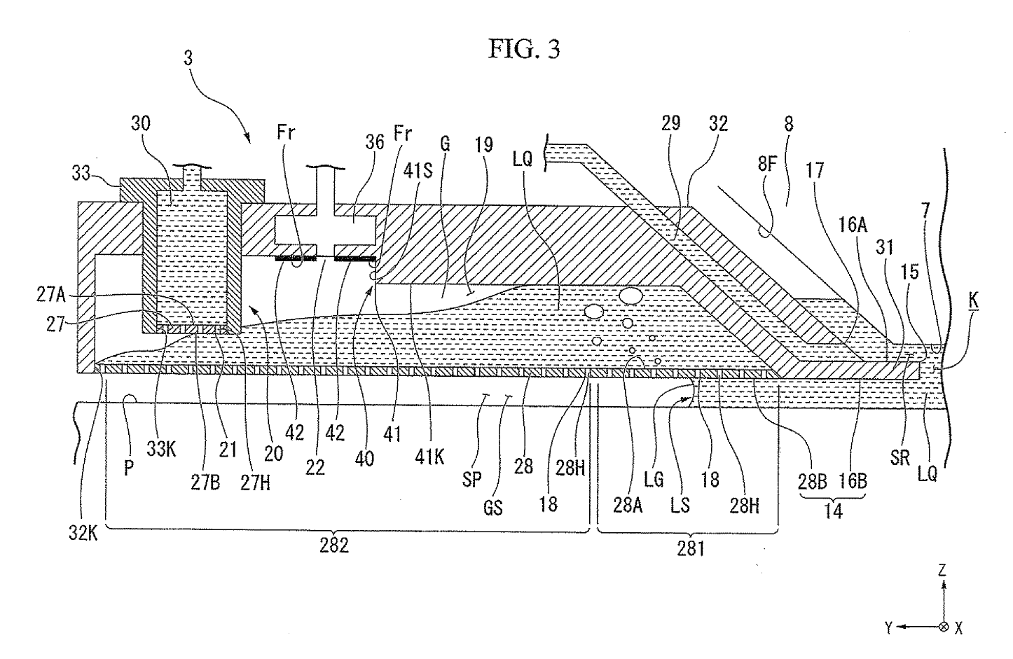

FIG. 2 is a side cross sectional view that shows one example of the liquid immersion member 3 according to the present embodiment, and FIG. 3 shows a partial enlarged view of FIG. 2. The text below explains an exemplary case, referencing FIG. 2 and FIG. 3, wherein the substrate P is disposed in the projection area PR, but the substrate stage 2P (i.e., the cover member T) and the measurement stage 2C (i.e., the measuring member C and the ultrasonic wave generating apparatus 13) can also be disposed in the projection area PR as discussed above.

In the present embodiment, the liquid immersion member 3 comprises a plate part 31, at least part of which is disposed such that the plate part 31 opposes the emergent surface 7, a main body part 32, at least part of which is disposed such that the main body part 32 opposes a side surface 8F of the last optical element 8, and a passageway forming member 33. In the present embodiment, the plate part 31 and the main body part 32 are one body. In the present embodiment, the passageway forming member 33 is different from the plate part 31 and the main body part 32. In the present embodiment, the passageway forming member 33 is supported by the main body part 32. Furthermore, the passageway forming member 33, the plate part 31, and the main body part 32 may be one body. Furthermore, the passageway forming member 33 may be replaceable and may be capable of separating from the main body part 32.

Furthermore, the side surface 8F is disposed around the emergent surface 7. In the present embodiment, the side surface 8F is inclined upward toward the outer side in radial directions with respect to the optical path K. Furthermore, the radial directions with respect to the optical path K include the radial directions with respect to the optical axis AX of the projection optical system PL as well as the directions perpendicular to the Z axis.

The liquid immersion member 3 has an opening 15, which is formed at a position at which the opening 15 faces the emergent surface 7. The exposure light EL that emerges from the emergent surface 7 can be radiated through the opening 15 to the substrate P. In the present embodiment, the plate part 31 has an upper surface 16A, which opposes at least part of the emergent surface 7, and a lower surface 16B, which is capable of opposing the front surface of the substrate P. The opening 15 is a hole that is formed such that the opening 15 connects the upper surface 16A and the lower surface 16B. The upper surface 16A is disposed around an upper end of the opening 15 and the lower surface 16B is disposed around a lower end of the opening 15.

In the present embodiment, the upper surface 16A is flat. The upper surface 16A is substantially parallel to the XY plane. Furthermore, at least part of the upper surface 16A may be tilted with respect to the XY plane and may include a curved surface. In the present embodiment, the lower surface 16B is flat. The lower surface 16B is substantially parallel to the XY plane. Furthermore, at least part of the lower surface 16B may be tilted with respect to the XY plane and may include a curved surface. The lower surface 16B holds the exposure liquid LQ between itself and the front surface of the substrate P.

The liquid immersion member 3 has: supply ports 17, which are capable of supplying the exposure liquid LQ; recovery ports 18, which are capable of recovering the exposure liquid LQ; a recovery passageway 19, wherethrough the exposure liquid LQ recovered via the recovery ports 18 flows; and discharge parts 20, which separately discharge the exposure liquid LQ and a gas G from the recovery passageway 19.

The supply ports 17 are capable of supplying the exposure liquid LQ to the optical path K. In the present embodiment, the supply ports 17 supply the exposure liquid LQ to the optical path K during at least part of the exposure of the substrate P. The supply ports 17 are disposed in the vicinity of the optical path K such that they face the optical path K. In the present embodiment, the supply ports 17 supply the exposure liquid LQ to a space SR between the emergent surface 7 and the upper surface 16A. At least some of the exposure liquid LQ supplied to the space SR via the supply ports 17 is supplied to the space above the substrate P via the opening 15 as well as to the optical path K. Furthermore, at least part of at least one of the supply ports 17 may face the side surface 8F.

The liquid immersion member 3 comprises supply passageways 29, which are connected to the supply ports 17. At least part of each of the supply passageways 29 is formed inside the liquid immersion member 3. In the present embodiment, each of the supply ports 17 includes an opening, which is formed at one end of the corresponding supply passageway 29. The other end of each of the supply passageways 29 is connected to a liquid supply apparatus 35 via a passageway 34 formed by a piping member 34P.

The liquid supply apparatus 35 is capable of delivering the exposure liquid LQ, which is clean and temperature adjusted. The exposure liquid LQ that is delivered from the liquid supply apparatus 35 is supplied to the supply ports 17 via passageways 30 and the supply passageways 29. The supply ports 17 supply the exposure liquid LQ from the supply passageways 29 to the optical path K (i.e., the space SR).

The recovery ports 18 are capable of recovering at least some of the exposure liquid LQ from the space above the substrate P (i.e., the object). The recovery ports 18 recover at least some of the exposure liquid LQ from the space above the substrate P during the exposure of the substrate P. The recovery ports 18 face the −Z direction. The front surface of the substrate P faces the recovery ports 18 during at least part of the exposure of the substrate P.

In the present embodiment, the liquid immersion member 3 comprises a first member 28, which has the recovery ports 18. The first member 28 has: a first surface 28B; a second surface 28A, which faces a direction other than that faced by the first surface 28B; and a plurality of holes 28H, which connect the first surface 28B and the second surface 28A. In the present embodiment, the recovery ports 18 include the holes 28H of the first member 28. In the present embodiment, the first member 28 is a porous member that has the plurality of holes 28H (i.e., openings or pores). Furthermore, the first member 28 may be a mesh filter, which is a porous member wherein numerous small holes are formed as a mesh. Namely, a variety of members that have holes capable of recovering the exposure liquid LQ can serve as the first member 28.

At least part of the recovery passageway 19 is formed inside the liquid immersion member 3. In the present embodiment, an opening 32K is formed in a lower end of the recovery passageway 19. The opening 32K is disposed at least partly around the lower surface 16B. The opening 32K is formed at the lower end of the main body part 32. The opening 32K faces downward (i.e., the −Z direction). In the present embodiment, the first member 28 is disposed in the opening 32K. The recovery passageway 19 includes a space between the main body part 32 and the first member 28. The exposure liquid LQ recovered via the recovery ports 18 flows through the recovery passageway 19.

The first member 28 is disposed at least partly around the optical path K (i.e., the lower surface 16B). In the present embodiment, the first member 28 is disposed around the optical path K. Furthermore, the annular first member 28 may be disposed around the optical path K (i.e., the lower surface 16B) or a plurality of the first members 28 may be disposed such that the first members 28 are distributed around the optical path K (i.e., the lower surface 16B).

In the present embodiment, the first member 28 is a plate shaped member. The first surface 28B is one surface of the first member 28 and the second surface 28A is the other surface of the first member 28. In the present embodiment, the first surface 28B faces the space SP, which is on the lower side (i.e., the −Z side) of the liquid immersion member 3. The space SP includes, for example, the space between the lower surface 14 of the liquid immersion member 3 and the front surface of the object (i.e., the substrate P and the like) that opposes the lower surface 14 of the liquid immersion member 3. If the immersion space LS is formed above the object (i.e., the substrate P and the like) opposing the lower surface 14 of the liquid immersion member 3, then the space SP includes the immersion space LS (i.e., a liquid space) and the gas space GS. In the present embodiment, the first member 28 is disposed in the opening 32K such that the first surface 28B faces the space SP and the second surface 28A faces the recovery passageway 19. In the present embodiment, the first surface 28B and the second surface 28A are substantially parallel. The first member 28 is disposed in the opening 32K such that the second surface 28A faces the +Z direction and the first surface 28B faces the opposite direction (i.e., the −Z direction) to that faced by the second surface 28A. In addition, in the present embodiment, the first member 28 is disposed in the opening 32K such that the first surface 28B and the second surface 28A are substantially parallel to the XY plane.

In the explanation below, the first surface 28B is called the lower surface 28B where appropriate, and the second surface 28A is called the upper surface 28A where appropriate.

Furthermore, the first member 28 does not have to be plate shaped. In addition, the lower surface 28B and the upper surface 28A may be nonparallel. In addition, at least part of the lower surface 28B may be tilted with respect to the XY plane and may include a curved surface. In addition, at least part of the upper surface 28A may be tilted with respect to the XY plane and may include a curved surface.

The holes 28H are formed such that they connect the lower surface 28B and the upper surface 28A. The fluid (i.e., the fluid containing the gas G or the exposure liquid LQ, or both) is capable of passing through the holes 28H of the first member 28. In the present embodiment, the recovery ports 18 include the openings at the lower ends of the holes 28H on the lower surface 28B side. The lower surface 28B is disposed around the lower ends of the holes 28H, and the upper surface 28A is disposed around the upper ends of the holes 28H.

The recovery passageway 19 is connected to the holes 28H (i.e., the recovery ports 18) of the first member 28. The first member 28 recovers at least some of the exposure liquid LQ from the space above the substrate P (i.e., the object) opposing the lower surface 28B via the holes 28H (i.e., the recovery ports 18). The exposure liquid LQ recovered via the holes 28H of the first member 28 flows through the recovery passageway 19.

In the present embodiment, the lower surface 14 of the liquid immersion member 3 includes the lower surface 16B and the lower surface 28B. In the present embodiment, the lower surface 28B is disposed at least partly around the lower surface 16B. In the present embodiment, the annular lower surface 28B is disposed around the lower surface 16B. Furthermore, a plurality of the lower surfaces 28B may be disposed such that the lower surfaces 28B are distributed around the lower surface 16B (i.e., the optical path K).

In the present embodiment, the first member 28 comprises a first portion 281 and a second portion 282. In the present embodiment, the second portion 282 is disposed on the outer side of the first portion 281 in radial directions with respect to the optical path K. In the present embodiment, the second portion 282 hinders the flow of the gas G from the space SP into the recovery passageway 19 via the holes 28H more than the first portion 281 does.

In the present embodiment, the inflow resistance of the gas G from the space SP into the recovery passageway 19 via the holes 28H is greater at the second portion 282 than at the first portion 281.

The first portion 281 and the second portion 282 each have a plurality of the holes 28H. For example, in the state wherein the immersion space LS is being formed in the space SP, some of the holes 28H among the plurality of the holes 28H of the first portion 281 might contact the exposure liquid LQ in the immersion space LS and some might not. In addition, some of the holes 28H among the plurality of the holes 28H of the second portion 282 might contact the exposure liquid LQ in the immersion space LS and some might not.

In the present embodiment, the first portion 281 is capable of recovering the exposure liquid LQ to the recovery passageway 19 via the holes 28H that contact the exposure liquid LQ in the space SP (i.e., the exposure liquid LQ in the space above the substrate P). In addition, the first portion 281 suctions the gas G into the recovery passageway 19 via the holes 28H that do not contact the exposure liquid LQ.

Namely, the first portion 281 is capable of recovering the exposure liquid LQ from the immersion space LS to the recovery passageway 19 via the holes 28H that face the immersion space LS, and the first portion 281 suctions the gas G into the recovery passageway 19 via the holes 28H that face the gas space GS, which is disposed on the outer side of the immersion space LS.

In other words, the first portion 281 is capable of recovering the exposure liquid LQ from the immersion space LS to the recovery passageway 19 via the holes 28H that face the immersion space LS, and the first portion 281 suctions the gas G into the recovery passageway 19 via the holes 28H that do not face the immersion space LS.

Namely, if the interface LG of the exposure liquid LQ in the immersion space LS is present between the first portion 281 and the substrate P, then the first portion 281 recovers to the recovery passageway 19 the exposure liquid LQ together with the gas G. Furthermore, at the interface LG, both the exposure liquid LQ and the gas G may be suctioned via the holes 28H that face both the immersion space LS and the gas space GS.

The second portion 282 is capable of recovering the exposure liquid LQ to the recovery passageway 19 via the holes 28H that contact the exposure liquid LQ in the space SP (i.e., the exposure liquid LQ in the space above the substrate P). In addition, the second portion 282 hinders the flow of the gas G into the recovery passageway 19 via the holes 28H that do not contact the exposure liquid LQ.

Namely, the second portion 282 is capable of recovering the exposure liquid LQ from the immersion space LS to the recovery passageway 19 via the holes 28H that face the immersion space LS, and the second portion 282 hinders the flow of the gas G into the recovery passageway 19 via the holes 28H that face the gas space GS, which is disposed on the outer side of the immersion space LS.

In the present embodiment, the second portion 282 recovers substantially only the exposure liquid LQ, and not the gas G, to the recovery passageway 19.

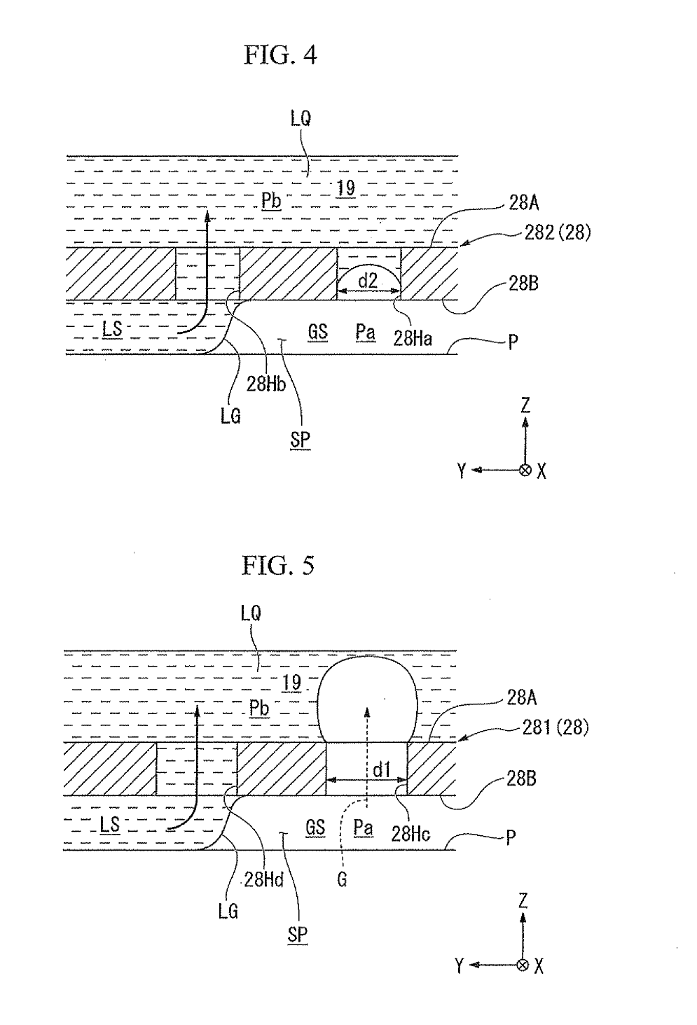

FIG. 4 is a partial enlarged cross sectional view of the second portion 282 of the first member 28 and serves as a schematic drawing for explaining one example of the state wherein the second portion 282 is recovering only the exposure liquid LQ.

In FIG. 4, there is a difference between a pressure Pa in the space SP (i.e., the gas space GS) and a pressure Pb in the recovery passageway 19. In the present embodiment, the pressure Pb in the recovery passageway 19 is lower than the pressure Pa in the space SP. When the exposure liquid LQ is being recovered from the space above the substrate P (i.e., the object) via the first member 28, the exposure liquid LQ is recovered from the space above the substrate P to the recovery passageway 19 via a hole 28Hb of the second portion 282, and the flow of the gas G into the recovery passageway 19 via a hole 28Ha of the second portion 282 is hindered.

In FIG. 4, the immersion space LS (i.e., the liquid space) and the gas space GS are formed in the space SP between the lower surface 28B of the second portion 282 and the front surface of the substrate P. In FIG. 4, the space that the lower end of the hole 28Ha of the second portion 282 faces is the gas space GS, and the space that the lower end of the hole 28Hb of the second portion 282 faces is the immersion space LS (i.e., the liquid space). In addition, in FIG. 4, the exposure liquid LQ in the recovery passageway 19 (i.e., a liquid space) is present on the upper side of the second portion 282.

In the present embodiment, the exposure liquid LQ is recovered from the space above the substrate P to the recovery passageway 19 via the hole 28Hb of the second portion 282, which contacts the exposure liquid LQ, and the flow of the gas G into the recovery passageway 19 via the hole 28Ha of the second portion 282, which does not contact the exposure liquid LQ, is hindered.

In FIG. 4, the condition below is satisfied.

(4×γ×cos θ2)/d2≧(Pb−Pa) (1)

Therein, Pa is the pressure in the gas space GS that the lower end of the hole 28Ha faces (i.e., the pressure on the lower surface 28B side), Pb is the pressure in the recovery passageway 19 (i.e., the liquid space) on the upper side of the first member 28 (i.e., the pressure on the upper surface 28A side), d2 is the dimension (i.e., the pore size or diameter) of each of the holes 28Ha, 28Hb, θ2 is the contact angle of the exposure liquid LQ with respect to the surface (i.e., the inner surface) of each of the holes 28H of the second portion 282, and γ is the surface tension of the exposure liquid LQ. Furthermore, to simplify the explanation, the condition expressed in the above-mentioned equation (1) does not take the hydrostatic pressure of the exposure liquid LQ on the upper side of the first member 28 into consideration.

Furthermore, in the present embodiment, the dimension d2 of each of the holes 28H of the second portion 282 indicates the minimum value thereof of all of the holes 28H between the upper surface 28A and the lower surface 28B. Furthermore, the dimension d2 does not have to be the minimum dimension of all of the holes 28H between the upper surface 28A and the lower surface 28B, and may be, for example, the average value or the maximum value thereof.

In this case, the contact angle θ2 of the exposure liquid LQ with respect to the surface of each of the holes 28H of the second portion 282 should satisfy the condition below.

θ2≦90° (2)

If the above condition holds, then, even if the gas space GS is formed on the lower side (i.e., on the space SP side) of the hole 28Ha of the first member 28, the gas G in the gas space GS on the lower side of the first member 28 is hindered from moving to (i.e., flowing into) the recovery passageway 19 (i.e., the liquid space) on the upper side of the first member 28 via the hole 28Ha. Namely, if the dimension d2 (i.e., the pore size or diameter) of each of the holes 28H of the second portion 282, the contact angle θ2 (i.e., the affinity) of the exposure liquid LQ with respect to the surface of each of the holes 28H of the second portion 282, the surface tension γ of the exposure liquid LQ, and the pressures Pa, Pb satisfy the above condition, then the interface between the exposure liquid LQ and the gas G is kept on the inner side of the hole 28Ha and the flow of the gas G from the space SP into the recovery passageway 19 via the hole 28Ha of the second portion 282 is hindered. Moreover, because the immersion space LS (i.e., the liquid space) is formed on the lower side (i.e., on the space SP side) of the hole 28Hb, only the exposure liquid LQ is recovered via the hole 28Hb.

In the present embodiment, the above condition is satisfied for all of the holes 28H of the second portion 282, and substantially only the exposure liquid LQ is recovered via the holes 28H of the second portion 282.

In the explanation below, the state wherein only the exposure liquid LQ is recovered via the holes of the porous member (e.g., the holes 28H of the first member 28) is called a liquid selective recovery state where appropriate, and the condition wherein only the exposure liquid LQ is recovered via the holes of the porous member is called a liquid selective recovery condition.

FIG. 5 is a partial enlarged cross sectional view of the first portion 281 of the first member 28 and serves as a schematic drawing for explaining one example of the state wherein the first portion 281 is recovering the exposure liquid LQ and the gas G.

In FIG. 5, there is a difference between the pressure Pa in the space SP (i.e., the gas space GS) and the pressure Pb in the recovery passageway 19. In the present embodiment, the pressure Pb in the recovery passageway 19 is lower than the pressure Pa in the space SP. When the exposure liquid LQ is being recovered from the space above the substrate P (i.e., the object) via the first member 28, the gas G is suctioned into the recovery passageway 19 via a hole 28Hc in the first portion 281.

In FIG. 5, the immersion space LS (i.e., the liquid space) and the gas space GS are formed in the space SP. In FIG. 5, the space that the lower end of the hole 28Hc of the first portion 281 faces is the gas space GS, and the space that the lower end of a hole 28Hd of the first portion 281 faces is the immersion space LS (i.e., the liquid space). In addition, in FIG. 5, the exposure liquid LQ in the recovery passageway 19 (i.e., the liquid space) is present on the upper side of the first portion 281.

In the present embodiment, the exposure liquid LQ is recovered from the space above the substrate P to the recovery passageway 19 via the hole 28Hd of the first portion 281, which contacts the exposure liquid LQ, and the gas G is suctioned into the recovery passageway 19 via the hole 28Hc of the first portion 281, which does not contact the exposure liquid LQ.

In the present embodiment, the dimension (i.e., the pore size or diameter) of each of the holes 28H or the contact angle of the exposure liquid LQ with respect to the surface (i.e., the inner surface) of each of the holes 28H, or both, is different at the first portion 281 than it is at the second portion 282. Owing to the difference between the pressure Pa in the space SP (i.e., the gas space GS) and the pressure Pb in the recovery passageway 19, the exposure liquid LQ is recovered from the space above the substrate P to the recovery passageway 19 via the hole 28Hd of the first portion 281, which contacts the exposure liquid LQ, and the gas G is suctioned into the recovery passageway 19 via the hole 28Hc of the first portion 281, which does not contact the exposure liquid LQ.

Furthermore, in the present embodiment, a dimension d1 of each of the holes 28H of the first portion 281 indicates the minimum value thereof of all of the holes 28H between the upper surface 28A and the lower surface 28B. Furthermore, the dimension d1 does not have to be the minimum dimension of all of the holes 28H between the upper surface 28A and the lower surface 28B, and may be, for example, the average value or the maximum value thereof.

In the present embodiment, the surface of each of the holes 28H of the second portion 282 is more lyophilic with respect to the exposure liquid LQ than the surface of each of the holes 28H of the first portion 281 is. Namely, the contact angle θ2 of the exposure liquid LQ with respect to the surface (i.e., the inner surface) of each of the holes 28H of the second portion 282 is smaller than a contact angle θ1 of the exposure liquid LQ with respect to the surface (i.e., the inner surface) of each of the holes 28H of the first portion 281. Thereby, the first portion 281 recovers the exposure liquid LQ together with the gas G, and the second portion 282 recovers the exposure liquid LQ while hindering the flow of the gas G into the recovery passageway 19.

In the present embodiment, the contact angle θ2 of the exposure liquid LQ with respect to the surface of each of the holes 28H of the second portion 282 is less than 90°. For example, the contact angle θ2 of the exposure liquid LQ with respect to the surface of each of the holes 28H of the second portion 282 may be less than 50°, less than 40°, less than 30°, or less than 20°.

Furthermore, the dimension d1 of each of the holes 28H of the first portion 281 may be different from the dimension d2 of each of the holes 28H of the second portion 282. For example, by making the dimension d2 of each of the holes 28H of the second portion 282 smaller than the dimension d1 of each of the holes 28H of the first portion 281, the first portion 281 recovers the exposure liquid LQ together with the gas G, and the second portion 282 recovers the exposure liquid LQ while hindering the flow of the gas G into the recovery passageway 19.

The text below explains the discharge parts 20, referencing FIG. 2 and FIG. 3, Each of the discharge parts 20 has first discharge ports 21, which face the recovery passageway 19 and are for discharging the exposure liquid LQ from the recovery passageway 19, and a second discharge port 22, which faces the recovery passageway 19 and is for discharging the gas G from the recovery passageway 19.

In the present embodiment, the first discharge ports 21 are disposed above (i.e., in the +Z direction of) the recovery ports 18 such that the first discharge ports 21 face the recovery passageway 19. The second discharge ports 22 are disposed above (i.e., in the +Z direction of) the recovery ports 18 such that the second discharge ports 22 face the recovery passageway 19.

In the present embodiment, the first discharge ports 21 or the second discharge ports 22, or both, face downward (i.e., in the −Z direction). In the present embodiment, the first discharge ports 21 and the second discharge ports 22 each face downward.

In the present embodiment, the first discharge ports 21 are disposed on the outer side of the second discharge ports 22 in radial directions with respect to the optical path K. Namely, in the present embodiment, the first discharge ports 21 are farther from the optical path K than the second discharge ports 22 are.

In the present embodiment, at least part of at least one of the first discharge ports 21 opposes the upper surface 28A of the second portion 282 of the first member 28. In the present embodiment, all of each of the first discharge ports 21 opposes the upper surface 28A of the second portion 282. The first discharge ports 21, which oppose the first member 28, oppose the recovery ports 18.

In the present embodiment, at least part of at least one of the second discharge ports 22 oppose the upper surface 28A of the second portion 282 of the first member 28. In the present embodiment, all of the second discharge ports 22 oppose the upper surface 28A of the second portion 282. The second discharge ports 22, which oppose the first member 28, oppose the recovery ports 18.

In the present embodiment, the first discharge ports 21 are disposed below the second discharge ports 22.

In addition, in the present embodiment, the second discharge ports 22 are disposed more spaced apart from the upper surface 28A of the first member 28 than the first discharge ports 21 are.

In addition, in the present embodiment, at least part of the second portion 282 is disposed on the outer side of the first discharge ports 21 and the second discharge ports 22 in the radial directions with respect to the optical path K. Namely, in the present embodiment, at least part of the second portion 282 is farther from the optical path K than the first discharge ports 21 and the second discharge ports 22 are. In the example shown in FIG. 2 and FIG. 3, an outer edge of the second portion 282 is disposed on the outer side of the first discharge ports 21 and the second discharge ports 22 in the radial directions with respect to the optical path K.

In addition, in the present embodiment, at least part of the first portion 281 of the first member 28 is disposed on the inner side of the first discharge ports 21 and the second discharge ports 22 in the radial directions with respect to the optical path K. Namely, in the present embodiment, at least part of the first portion 281 is closer to the optical path K than the first discharge ports 21 and the second discharge ports 22 are. In the example shown in FIG. 2 and FIG. 3, substantially the entire first portion 281 is disposed on the inner side of the first discharge ports 21 and the second discharge ports 22 in the radial directions with respect to the optical path K.

As discussed above, the first member 28 (i.e., the first portion 281) recovers the exposure liquid LQ together with the gas G from the space SP to the recovery passageway 19. The exposure liquid LQ and the gas G in the space SP between the substrate P and the first member 28 flow to the recovery passageway 19 via the first member 28. As shown in FIG. 2 and FIG. 3, a gas space and the liquid space are formed in the recovery passageway 19. The first discharge ports 21 discharge the exposure liquid LQ from the recovery passageway 19, and the second discharge ports 22 discharge the gas G from the recovery passageway 19.

In the present embodiment, the first discharge ports 21 hinder the inflow of the gas G more than the second discharge ports 22 do. The second discharge ports 22 hinder the discharge of the exposure liquid LQ more than the first discharge ports 21 do. In other words, the second discharge ports 22 hinder the inflow of the exposure liquid LQ more than the first discharge ports 21 do.

In the present embodiment, the first discharge ports 21 discharge the fluid, which includes the exposure liquid LQ and wherein the percentage of the exposure liquid LQ is higher than the percentage of the gas G, from the recovery passageway 19. The second discharge ports 22 discharge the fluid, which includes the gas G and wherein the percentage of the exposure liquid LQ is lower than the percentage of the gas G, from the recovery passageway 19. Namely, in the present embodiment, the percentage of the exposure liquid LQ in the fluid discharged via the first discharge ports 21 is higher than the percentage of the exposure liquid LQ in the fluid discharged via the second discharge ports 22. In the present embodiment, the percentage of the gas G in the fluid discharged via the first discharge ports 21 is lower than the percentage of the gas G in the fluid discharged via the second discharge ports 22.

In the present embodiment, the first discharge ports 21 discharge substantially only the exposure liquid LQ from the recovery passageway 19. The second discharge ports 22 discharge substantially only the gas G from the recovery passageway 19.

In the present embodiment, the liquid immersion member 3 comprises second members 27, which have the first discharge ports 21. Each of the second members 27 has: a third surface 27B, which faces the recovery passageway 19; a fourth surface 27A, which faces a direction other than that faced by the third surface 27B; and multiple holes 27H, which connect the third surface 27B and the fourth surface 27A. In the present embodiment, the first discharge ports 21 include the holes 27H of the second members 27. In the present embodiment, each of the second members 27 is a porous member that has the multiple holes 27H. Furthermore, each of the second members 27 may be a mesh filter, which is a porous member wherein numerous small holes are formed as a mesh. Namely, a variety of members that have holes capable of hindering the inflow of the gas G can serve as each of the second members 27.

In the present embodiment, openings 33K are formed at the lower end of the passageway forming member 33. The openings 33K face downward (i.e., the −Z direction). In the present embodiment, the second members 27 are disposed in the openings 33K.

In the present embodiment, the second members 27 are plate shaped members. Each of the third surfaces 27B is one surface of the corresponding second member 27, and each of the fourth surfaces 27A is the other surface of the corresponding second member 27. In the present embodiment, the second members 27 are disposed in the openings 33K such that the third surfaces 27B face the recovery passageway 19 and the fourth surfaces 27A face the passageways 30 of the passageway forming member 33. In the present embodiment, the third surfaces 27B and the fourth surfaces 27A are substantially parallel. The second members 27 are disposed in the openings 33K such that the fourth surfaces 27A face the +Z direction and the third surfaces 27B face the opposite direction (i.e., the −Z direction) to that faced by the fourth surfaces 27A. In addition, in the present embodiment, the second members 27 are disposed in the openings 33K such that the third surfaces 27B and the fourth surfaces 27A are substantially parallel to the XY plane.

In the explanation below, the third surfaces 27B are called the lower surfaces 27B where appropriate, and the fourth surfaces 27A are called the upper surfaces 27A where appropriate.

Furthermore, the second members 27 do not have to be plate shaped members. In addition, the lower surfaces 27B and the upper surfaces 27A may be nonparallel. In addition, at least part of each of the lower surfaces 27B may be tilted with respect to the XY plane and may include a curved surface. In addition, at least part of each of the upper surfaces 27A may be tilted with respect to the XY plane and may include a curved surface.

The holes 27H are disposed such that they connect each of the lower surfaces 27B to the corresponding upper surface 27A. The fluid (i.e., the fluid containing the exposure liquid LQ or the gas G, or both) can flow through the holes 27H of the second members 27. In the present embodiment, each of the first discharge ports 21 is disposed at the lower ends of the holes 27H on the corresponding lower surface 27B side. In other words, the first discharge ports 21 are the openings at the lower ends of the holes 27H. Each of the lower surfaces 27B is disposed around the lower ends of the corresponding holes 27H, and each of the upper surfaces 27A is disposed around the upper ends of the corresponding holes 27H.

Each of the passageways 30 are connected to the holes 27H (i.e., the first discharge ports 21) of the corresponding second member 27. The second members 27 discharge at least some of the exposure liquid LQ from the recovery passageway 19 via the holes 27H (i.e., the first discharge ports 21). The exposure liquid LQ discharged via the holes 27H of the second members 27 flows through the passageways 30.

In the present embodiment, the pressure differential between the recovery passageway 19 that the lower surfaces 27B face and the passageways 30 (i.e., the spaces) that the upper surfaces 27A face is adjusted such that the discharge of the gas G via the first discharge ports 21 is hindered.

In the present embodiment, the second members 27 discharge substantially only the exposure liquid LQ, and not the gas G, to the passageways 30.

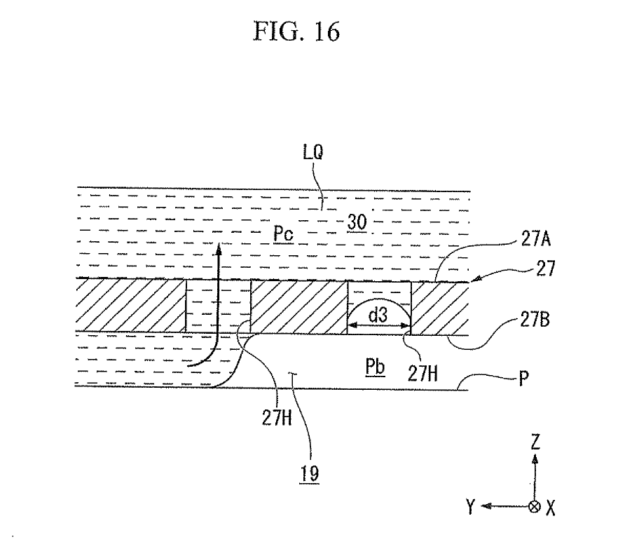

In the present embodiment, the recovery condition (i.e., the discharge condition) of the exposure liquid LQ via the holes 27H of the second members 27 satisfies the liquid selective recovery condition, as explained referencing FIG. 4 and the like. Namely, as shown in FIG. 16, by making a dimension d3 (i.e., the pore size or diameter) of each of the holes 27H of the second members 27, a contact angle θ3 (i.e., the affinity) of the exposure liquid LQ with respect to the surface of each of the holes 27H of the second members 27, the surface tension γ of the exposure liquid LQ, the pressure Pb in the recovery passageway 19 that the lower surfaces 27B face, and a pressure Pc in the passageways 30 that the upper surfaces 27A face satisfy the liquid selective recovery condition, the interface between the exposure liquid LQ and the gas G is kept on the inner side of the holes 27H and the flow of the gas G from the recovery passageway 19 into the passageways 30 via the holes 27H of the second members 27 is hindered. Thereby, the second members 27 (i.e., the first discharge ports 21) can discharge substantially only the exposure liquid LQ.

In the present embodiment, the difference between the pressure Pb in the recovery passageway 19 and the pressure Pc in the passageways 30 is adjusted such that the recovery condition (i.e., the discharge condition) of the exposure liquid LQ via the holes 27H of the second members 27 is the liquid selective recovery condition. The pressure Pc is lower than the pressure Pb. Namely, the difference between the pressure Pb in the recovery passageway 19 and the pressure Pc in the passageways 30 is prescribed such that the exposure liquid LQ is discharged from the recovery passageway 19 to the passageways 30 via the holes 27H of the second members 27 and the gas G is hindered from flowing into the passageways 30 via the holes 27H of the second members 27. By adjusting the pressure Pb or the pressure Pc, or both, the second members 27 discharge substantially only the exposure liquid LQ, and not the gas G, to the passageways 30 via the holes 27H.

In the present embodiment, at least part of the surface of each of the second members 27 is lyophilic with respect to the exposure liquid LQ. In the present embodiment, at least the surfaces (i.e., the inner surfaces) of the holes 27H of the second members 27 are lyophilic with respect to the exposure liquid LQ. In the present embodiment, the contact angle of the exposure liquid LQ with respect to the surface of each of the holes 27H is less than 90°. Furthermore, the contact angle of the exposure liquid LQ with respect to the surface of each of the holes 27H may be less than 50°, less than 40°, less than 30°, or less than 20°.

In the present embodiment, the liquid immersion member 3 comprises a hindering part 40, which is disposed in the recovery passageway 19 and hinders the exposure liquid LQ in the recovery passageway 19 from contacting the second discharge ports 22. The hindering part 40 is provided in the recovery passageway 19 such that the second discharge ports 22 are disposed in the gas space of the recovery passageway 19. Namely, the hindering part 40 is provided in the recovery passageway 19 such that the peripheral space of each of the second discharge ports 22 in the recovery passageway 19 is the gas space. For example, the hindering part 40 adjusts the interface (i.e., the surface) of the liquid space in the recovery passageway 19 such that the exposure liquid LQ does not contact the second discharge ports 22. Thereby, the second discharge ports 22 disposed in the gas space discharge substantially only the gas G from the recovery passageway 19.

In the present embodiment, the hindering part 40 comprises a projection 41, which is disposed at least partly around the second discharge ports 22. The projection 41 is provided inside the recovery passageway 19 such that the second discharge ports 22 are disposed in the gas space in the recovery passageway 19. The projection 41 limits the movement of the interface of the liquid space in the recovery passageway 19 such that the second discharge ports 22 are disposed in the gas space in the recovery passageway 19. Namely, the projection 41 hinders the interface of the liquid space in the recovery passageway 19 from approaching the second discharge ports 22.

In addition, in the present embodiment, the hindering part 40 comprises a liquid repellent part 42, which is disposed inside the recovery passageway 19 at least partly around the second discharge ports 22 and whose surface is liquid repellent with respect to the exposure liquid LQ. The liquid repellent part 42 hinders contact between the second discharge ports 22 and the exposure liquid LQ in the recovery passageway 19. The liquid repellent part 42 is provided inside the recovery passageway 19 such that the second discharge ports 22 are disposed in the gas space in the recovery passageway 19. The liquid repellent part 42 hinders the interface of the liquid space in the recovery passageway 19 from approaching the second discharge ports 22 such that the peripheral space of each of the second discharge ports 22 inside the recovery passageway 19 is the gas space.

In the present embodiment, the second discharge ports 22 are disposed on the outer side of the projection 41 in radial directions with respect to the optical path K. Namely, the second discharge ports 22 are farther from the optical path K than the projection 41 is. In addition, at least part of the liquid repellent part 42 is disposed between the second discharge ports 22 and the projection 41.

In the present embodiment, the projection 41 is disposed between the second discharge ports 22 and at least some of the recovery ports 18 in the radial directions with respect to the optical path K. In the present embodiment, the projection 41 is disposed between the recovery ports 18 of the first portion 281 and the second discharge ports 22 in the radial directions with respect to the optical path K.

The projection 41 projects downward at least partly around the second discharge ports 22. In the present embodiment, the projection 41 is formed by at least part of the inner surface of the recovery passageway 19. In the present embodiment, the surfaces of the projection 41 include a side surface 41S, which extends downward at least partly around the second discharge ports 22, and a lower surface 41K, which extends from a lower end part of the side surface 41S such that it approaches the optical path K proceeding from the inner sides of the second discharge ports 22. The side surface 41S faces the outer side in the radial directions with respect to the optical path K. The side surface 41S is substantially parallel to the optical path K. The side surface 41S is substantially parallel to the Z axis. Furthermore, the side surface 41S does not have to be parallel to the Z axis. The lower surface 41K faces the −Z direction. In the present embodiment, the lower surface 41K is substantially parallel to the XY plane. The side surface 41S and the lower surface 41K are part of the inner surface of the recovery passageway 19. In the present embodiment, the angle formed between the lower surface 41K and the side surface 41S is substantially 90°. Furthermore, the angle formed between the lower surface 41K and the side surface 41S may be less than or greater than 90°. In the present embodiment, the tip (i.e., the lower end) of the projection 41 is disposed at a position that is lower than the second discharge ports 22.

In the present embodiment, the lower surface 41K and the side surface 41S of the inner surface of the recovery passageway 19, which form the projection 41, are lyophilic with respect to the exposure liquid LQ. In the present embodiment, the lyophilic lower surface 41K and the lyophilic side surface 41S are adjacent to the liquid repellent part 42. At least part of the liquid repellent part 42 is disposed between the lyophilic lower surface 41K and the lyophilic side surface 41S on one side and the second discharge ports 22 on the other side.

In the present embodiment, the contact angle of the exposure liquid LQ with respect to the lyophilic inner surface (i.e., the lower surface 41K and the side surface 41S) of the recovery passageway 19 is less than 90°. The contact angle of the exposure liquid LQ with respect to the surface of the liquid repellent part 42 is 90° or greater. In the present embodiment, the contact angle of the exposure liquid LQ with respect to the surface of the liquid repellent part 42 may be, for example, 100° or greater or 110° or greater.

In the present embodiment, the liquid repellent part 42 is formed with films Fr that are liquid repellent with respect to the exposure liquid LQ. The material used to form the films Fr is fluorine based. In the present embodiment, the films Fr are tetrafluoroethylene-perfluoro (alkyl vinyl ether) copolymer (PFA) films. Furthermore, the films Fr may also be, for example, polytetrafluoroethylene (PTFE) films, polyetheretherketone (PEEK) films, or Teflon® films. In addition, the films Fr may also be Cytop™ (made by Asahi Glass Co.) or Novec EGC™ (made by 3M Company) films.

In the present embodiment, the first discharge ports 21 and the second discharge ports 22 are disposed at least partly around the optical path K. In the present embodiment, the second members 27, which each have the first discharge ports 21, are disposed at prescribed intervals around the optical path K. In the present embodiment, the second members 27 are disposed at four locations around the optical path K. The second discharge ports 22 are disposed at prescribed intervals around the optical path K. Furthermore, the number of the first discharge ports 21 and the number of the second discharge ports 22 may be the same. In addition, the first discharge ports 21 may be provided continuously around the optical path K, the second discharge ports 22 may be provided continuously around the optical path K, or both may be so provided.

As shown in FIG. 2, each of the first discharge ports 21 is connected to a first discharge apparatus 24 via the corresponding passageway 30 and a passageway 23, which is formed by a piping member 23P. The second discharge ports 22 are connected to a second discharge apparatus 26 via a passageway 36, which is formed inside the main body part 32, and a passageway 25, which is formed by a piping member 25P. Each of the first and second discharge apparatuses 24, 26 comprises, for example, a vacuum system and is capable of suctioning the fluid (i.e., the fluid containing the gas G or the exposure liquid LQ, or both).

In the present embodiment, a discharge operation is performed via the first discharge ports 21 by the operation of the first discharge apparatus 24. In addition, in the present embodiment, a discharge operation is performed via the second discharge ports 22 by the operation of the second discharge apparatus 26.

In the present embodiment, the first discharge apparatus 24 is capable of adjusting the pressure Pc in the passageways 30 that the upper surfaces 27A of the second members 27 face. In addition, the second discharge apparatus 26 is capable of adjusting the pressure Pb in the recovery passageway 19 that the lower surfaces 27B of the second members 27 and the upper surface 28A of the first member 28 face. In addition, the internal space CS includes the space SP, and the chamber apparatus 100 is capable of adjusting the pressure Pa in the space SP that the lower surface 28B of the first member 28 faces. The control apparatus 4 uses the chamber apparatus 100 or the second discharge apparatus 26, or both, to adjust the pressure Pa or the pressure Pb, or both, such that the first portion 281 of the first member 28 recovers the exposure liquid LQ together with the gas G from the space SP and such that the second portion 282 recovers the exposure liquid LQ while hindering the inflow of the gas G. In addition, the control apparatus 4 uses the first discharge apparatus 24 or the second discharge apparatus 26, or both, to set the pressure Pb or the pressure Pc, or both, such that the second members 27 discharge the exposure liquid LQ from the recovery passageway 19 while hindering the inflow of the gas G. Furthermore, the second discharge apparatus 26 does not have to be capable of adjusting the pressure Pb.

Furthermore, the exposure apparatus EX may comprise the first discharge apparatus 24 or the second discharge apparatus 26, or both. Furthermore, the first discharge apparatus 24 or the second discharge apparatus 26, or both, may be an apparatus that is external to the exposure apparatus EX. Furthermore, the first discharge apparatus 24 or the second discharge apparatus 26, or both, may be equipment in the factory wherein the exposure apparatus EX is installed.

In the present embodiment, the first discharge ports 21 are capable of supplying a liquid to the recovery passageway 19. Namely, in the present embodiment, the first discharge ports 21 can function as liquid supply ports that are capable of supplying the liquid.

In the present embodiment, a supply apparatus 241, which is capable of supplying the liquid, is connected to the passageway 23 via a passageway 231 formed by a piping member 231P. The passageway 231 is connected to the passageway 23 via a passageway switching mechanism 23B, which comprises, for example, a valve mechanism. The supply apparatus 241 is capable of supplying the liquid to the first discharge ports 21 via the passageway 231 and the passageway 23. The first discharge ports 21 are capable of supplying the liquid from the supply apparatus 241 to the recovery passageway 19. When the exposure liquid LQ is discharged from the recovery passageway 19 via the first discharge ports 21, the control apparatus 4 controls the passageway switching mechanism 23B such that the first discharge ports 21 are connected to the first discharge apparatus 24 via the passageway 23 and not to the supply apparatus 241. In the state wherein the passageway switching mechanism 23B connects the first discharge ports 21 and the first discharge apparatus 24 via the passageway 23, the fluid is discharged from the recovery passageway 19 via the first discharge ports 21 by the operation of the first discharge apparatus 24. Moreover, when the liquid is supplied to the recovery passageway 19 via the first discharge ports 21, the control apparatus 4 controls the passageway switching mechanism 23B such that the first discharge ports 21 are connected to the supply apparatus 241 via the passageway 23 and the passageway 231 and not to the first discharge apparatus 24. In the state wherein the passageway switching mechanism 23B connects the first discharge ports 21 and the supply apparatus 241 via the passageway 23 and the passageway 231, the liquid is supplied to the recovery passageway 19 via the first discharge ports 21 by the operation of the supply apparatus 241.

In the present embodiment, the liquid that is capable of being supplied via the first discharge ports 21 includes at least one of the following liquids: cleaning liquids LC (LC1, LC2) for cleaning, for example, at least some of the members of the exposure apparatus EX; and a rinsing liquid LH for eliminating any of the cleaning liquids LC that remain on those members. In the present embodiment, the cleaning liquids LC include the first cleaning liquid LC1 and the second cleaning liquid LC2. The supply apparatus 241 is capable of delivering the cleaning liquids LC or the rinsing liquid LH, or both.

In the present embodiment, at least part of the surface of the liquid immersion member 3 includes a surface of an amorphous carbon film. The amorphous carbon film may be a tetrahedral amorphous carbon film. In the present embodiment, at least part of the surface of the liquid immersion member 3 includes a surface of a tetrahedral amorphous carbon film. In the present embodiment, at least part of the surface of the liquid immersion member 3 that contacts the exposure liquid LQ in the immersion space LS during an exposure of the substrate P includes a surface of an amorphous carbon film (i.e., a tetrahedral amorphous carbon film). In the present embodiment, the base material of the plate part 31 and the main body part 32 may be titanium, and the amorphous carbon film is formed on the surface of that base material. In the present embodiment, the base material of the first member 28 and the second members 27 may be titanium, and the amorphous carbon film is formed on the surface of that base material.

Furthermore, the base material of the liquid immersion member 3, which comprises the plate part 31, the main body part 32, the first member 28, or the second members 27, or any combination thereof, may be a metal, such as stainless steel or aluminum, or a ceramic material.

Furthermore, the amorphous carbon film may be formed on the base material using, for example, chemical vapor deposition (CVD), physical vapor deposition (PVD), and the like. Furthermore, at least part of the surface of the liquid immersion member 3 does not have to include the surface of the amorphous carbon film.

Furthermore, at least part of the liquid immersion member 3 may include a material other than titanium, for example, stainless steel or magnesium. In addition, at least part of the liquid immersion member 3 may even be formed from a ceramic material.

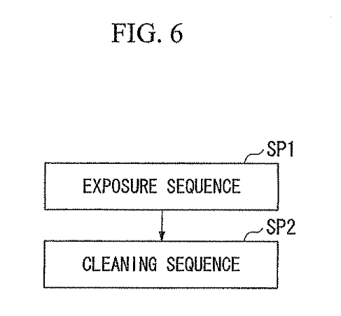

The text below explains one example of the operation of the exposure apparatus EX, which has the configuration discussed above. As in the flow chart shown in FIG. 6, in the present embodiment, an exposure sequence (i.e., a step SP1), which includes the exposing process that is performed on the substrate P, and a cleaning sequence (i.e., a step SP2), which includes a cleaning process that is performed on the liquid immersion member 3, are performed. Furthermore, the exposure sequence may be performed after the cleaning sequence, and the exposure sequence and the cleaning sequence may be performed repeatedly. In addition, the cleaning sequence may be performed at prescribed intervals or if it is determined that the liquid immersion member 3 has become contaminated, or in both cases.

First, the exposure sequence (i.e., the step SP1) will be explained. To load the unexposed substrate P onto the substrate stage 2P (i.e., the substrate holding part 10), the control apparatus 4 moves the substrate stage 2P to a substrate exchange position. The substrate exchange position is a position spaced apart from the liquid immersion member 3 (i.e., the projection area PR) and is where the substrate P exchanging process can be performed. The substrate P exchanging process includes at least one of the following processes: a process that unloads the exposed substrate P, which is held by the substrate stage 2P (i.e., the substrate holding part 10), from the substrate stage 2P using a prescribed transport apparatus (not shown); and a process that loads the unexposed substrate P onto the substrate stage 2P (i.e., the substrate holding part 10). The control apparatus 4 moves the substrate stage 2P to the substrate exchange position and performs the substrate P exchanging process.

During at least part of the interval during which the substrate stage 2P is spaced apart from the liquid immersion member 3, the control apparatus 4 disposes the measurement stage 2C at a position at which it opposes the last optical element 8 and the liquid immersion member 3 and forms the immersion space LS by holding the exposure liquid LQ between the last optical element 8 and the liquid immersion member 3 on one side and the measurement stage 2C on the other side.

In addition, during at least part of the interval during which the substrate stage 2P is spaced apart from the liquid immersion member 3, the measuring process may be performed, as needed, using the measurement stage 2C. When the measuring process using the measurement stage 2C is to be performed, the control apparatus 4 causes the last optical element 8 and the liquid immersion member 3 on one side and the measurement stage 2C on the other side to oppose one another and forms the immersion space LS such that the optical path K of the exposure light EL between the last optical element 8 and the measuring member C is filled with the exposure liquid LQ. The control apparatus 4 performs the exposure light EL measuring process by radiating the exposure light EL through the projection optical system PL and the exposure liquid LQ to the measuring member C (i.e., the measuring instrument) held by the measurement stage 2C. The result of that measuring process may be subsequently reflected in the exposing process to be performed on the substrate P.

After the unexposed substrate P is loaded onto the substrate stage 2P and the measuring process that uses the measurement stage 2C has ended, the control apparatus 4 moves the substrate stage 2P to the projection area PR and forms the immersion space LS between the last optical element 8 and the liquid immersion member 3 on one side and the substrate stage 2P (i.e., the substrate P) on the other side.

In the present embodiment, the immersion space LS is formed with the exposure liquid LQ between the last optical element 8 and the liquid immersion member 3 on one side and the substrate P (i.e., the object) on the other side by recovering the exposure liquid LQ via the recovery ports 18 in parallel with supplying the exposure liquid LQ via the supply ports 17.

Furthermore, in the present embodiment, as shown in FIG. 2 and FIG. 3, in the state wherein the object (i.e., the substrate P) opposing the last optical element 8 and the liquid immersion member 3 is substantially stationary, the interface LG of the exposure liquid LQ in the immersion space LS is formed between the first portion 281 and the object.

Furthermore, in the state wherein the object is substantially stationary, the interface LG of the exposure liquid LQ in the immersion space LS is formed between the second portion 282 and the object.

The control apparatus 4 starts the process of exposing the substrate P. The control apparatus 4 radiates the exposure light EL, which emerges from the mask M illuminated with the exposure light EL from the illumination system IL, to the substrate P through the projection optical system PL and the exposure liquid LQ in the immersion space LS. Thereby, the substrate P is exposed with the exposure light EL, which transits the exposure liquid LQ in the immersion space LS and emerges from the emergent surface 7, and thus the image of the pattern of the mask M is projected to the substrate P.

When recovering the exposure liquid LQ via the recovery ports 18, the control apparatus 4 operates the second discharge apparatus 26 to discharge the gas G from the recovery passageway 19 via the second discharge ports 22. Thereby, the pressure Pb in the recovery passageway 19 decreases. In the present embodiment, the control apparatus 4 controls the second discharge apparatus 26 such that the pressure Pb in the recovery passageway 19 is lower than the pressure Pa in the space SP. By making the pressure Pb lower than the pressure Pa, at least some of the exposure liquid LQ is recovered from the space above the substrate P to the recovery passageway 19 via the holes 28H of the first portion 281 of the first member 28 or the holes 28H of the second portion 282 of the first member 28, or both. In addition, at least some of the gas G is recovered from the space SP to the recovery passageway 19 via the holes 28H. The exposure liquid LQ and the gas G are separately discharged from the recovery passageway 19 via the discharge parts 20.

In the present embodiment, the discharge operation via the second discharge ports 22 is performed in the state wherein the hindering part 40, which comprises the projection 41 and the liquid repellent part 42, is disposed at least partly around the second discharge ports 22. The gas G is discharged from the recovery passageway 19 via the second discharge ports 22 while the hindering part 40 hinders the exposure liquid LQ in the recovery passageway 19 from contacting the second discharge ports 22. Furthermore, the hindering part 40 may have either just the projection 41 or just the liquid repellent part 42.

In the present embodiment, the exposure liquid LQ and the gas G flow in the recovery passageway 19 such that the exposure liquid LQ in the recovery passageway 19 contacts the first discharge ports 21 but not the second discharge ports 22. In the present embodiment, the arrangement of the first discharge ports 21, the second discharge ports 22, the recovery ports 18, and the like, and, for example, the shape of the inner surface of the recovery passageway 19, a characteristic (e.g., the contact angle) of the inner surface of the recovery passageway 19 with respect to the exposure liquid LQ, the shape of the surface of each of the members that faces the recovery passageway 19, and a characteristic (e.g., the contact angle) of the surface of the members that face the recovery passageway 19 with respect to the exposure liquid LQ are prescribed such that the exposure liquid LQ recovered to the recovery passageway 19 via the holes 28H of the first member 28 flows toward the first discharge ports 21 without contacting the second discharge ports 22.

In the present embodiment, the exposure liquid LQ, together with the gas G, is recovered to the recovery passageway 19 via the first portion 281 of the first member 28, and the exposure liquid LQ is recovered to the recovery passageway 19 via the second portion 282 of the first member 28 while the flow of the gas G into the recovery passageway 19 via the second portion 282 is hindered.

By virtue of the pressure Pb in the recovery passageway 19 being made lower than the pressure Pa in the space SP between the liquid immersion member 3 and the substrate P, the exposure liquid LQ in the space above the substrate P flows into the recovery passageway 19 via the recovery ports 18 (i.e., the first member 28). Namely, because a pressure differential is generated between the upper surface 28A and the lower surface 28B of the first member 28, the exposure liquid LQ in the space above the substrate P flows into the recovery passageway 19 via the recovery ports 18 (i.e., the first member 28).

In addition, the control apparatus 4 both controls the passageway switching mechanism 23B such that the first discharge apparatus 24 and the first discharge ports 21 are connected and operates the first discharge apparatus 24 to discharge the exposure liquid LQ from the recovery passageway 19 via the first discharge ports 21. The operation of the first discharge apparatus 24 lowers the pressure in the passageways 30. In the present embodiment, the control apparatus 4 controls the first discharge apparatus 24 such that the pressure Pc in the passageways 30 becomes lower than the pressure Pb in the recovery passageway 19.

The control apparatus 4 controls the first discharge apparatus 24 and thereby controls the pressure Pc in the passageways 30 such that only the exposure liquid LQ is discharged to the passageways 30 via the second members 27.

By virtue of the pressure Pc in the passageways 30 becoming lower than the pressure Pb in the recovery passageway 19, the exposure liquid LQ in the recovery passageway 19 flows into the passageways 30 via the first discharge ports 21 (i.e., the second members 27). Namely, by virtue of a pressure differential being generated between the upper surfaces 27A and the lower surfaces 27B of the second members 27, the exposure liquid LQ in the recovery passageway 19 flows into the passageways 30 via the first discharge ports 21 (i.e., the second members 27).

During the recovery of the exposure liquid LQ via the recovery ports 18, the exposure liquid LQ continues to be discharged from the recovery passageway 19 via the first discharge ports 21. To recover the exposure liquid LQ via the recovery ports 18, the second discharge ports 22 continue to discharge the gas G from the recovery passageway 19.

To discharge only the gas G from the recovery passageway 19, the second discharge ports 22 hinder the pressure Pb in the recovery passageway 19 from fluctuating greatly. Namely, the pressure Pb in the recovery passageway 19 is held substantially constant by ensuring a continuous gas passageway between the second discharge apparatus 26 and the gas space at the upper part of the recovery passageway 19 and by the second discharge ports 22 continuing to discharge the gas G from the recovery passageway 19. Because the pressure Pb in the recovery passageway 19 is substantially constant, fluctuations in the amount of the exposure liquid LQ recovered per unit of time from the space above the substrate P (i.e., in the immersion space LS) via the recovery ports 18 are hindered.

In the present embodiment, to form the immersion space LS, the supply ports 17 supply a prescribed amount of the exposure liquid LQ per unit of time. In the present embodiment, the supply ports 17 continue to supply a substantially constant amount of the exposure liquid LQ. In addition, the recovery ports 18 recover a prescribed amount of the exposure liquid LQ per unit of time. In the present embodiment, the recovery ports 18 continue to recover a substantially constant amount of the exposure liquid LQ. Accordingly, large fluctuations in the immersion space LS are hindered.

In the present embodiment, the exposure liquid LQ recovered to the recovery passageway 19 via the recovery ports 18 flows toward the first discharge ports 21 (i.e., the second members 27) while contacting at least part of the inner surface of the recovery passageway 19. The exposure liquid LQ in the recovery passageway 19 that contacts any of the first discharge ports 21 (i.e., the second members 27) is discharged via those first discharge ports 21. For example, the exposure liquid LQ recovered via the holes 28H of the first portion 281 flows on the upper surface 28A of the first member 28 toward the first discharge ports 21 (i.e., the second members 27). The exposure liquid LQ is discharged from the recovery passageway 19 via the first discharge ports 21 such that the flow of the gas G from the recovery passageway 19 into the second discharge ports 22 is maintained. The control apparatus 4 controls the first discharge apparatus 24 or the second discharge apparatus 26, or both, such that the discharge of the gas G via the second discharge ports 22 continues and such that the exposure liquid LQ is discharged via the first discharge ports 21.

In the present embodiment, when the exposure liquid LQ is being recovered from the space above the substrate P via the first member 28, at least the upper surface 28A of the second portion 282 is covered by the exposure liquid LQ in the recovery passageway 19. In the present embodiment as shown in FIG. 2 and FIG. 3, in the recovery passageway 19, substantially the entire area of the upper surface 28A of the first member 28 is covered by the exposure liquid LQ in the recovery passageway 19. Namely, in the recovery passageway 19, substantially the entire upper surface 28A contacts the exposure liquid LQ. Thereby, the liquid selective recovery condition is satisfied for the majority of the holes 28H of the second portion 282, and substantially only the exposure liquid LQ is recovered via the second portion 282.

After the substrate P exposing process is complete, the control apparatus 4 moves the substrate stage 2P to the substrate exchange position. The measurement stage 2C is disposed such that it opposes, for example, the last optical element 8 and the liquid immersion member 3. The exposed substrate P is unloaded from the substrate stage 2P, which has moved to the substrate exchange position, and the unexposed substrate P is loaded onto the substrate stage 2P.

Below, the control apparatus 4 performs the processes discussed above repetitively to sequentially expose a plurality of the substrates P.

Furthermore, in the present embodiment, during at least part of the interval of the exposure sequence, which includes the substrate P exchanging process, the measuring process using the measurement stage 2C, and the substrate P exposing process, the exposure liquid LQ is supplied via the supply ports 17 to the space between the last optical element 8 and the liquid immersion member 3 on one side and the object (i.e., the substrate P, the substrate stage 2P or the measurement stage 2C, or any combination thereof), which is disposed opposing the last optical element 8 and the liquid immersion member 3, on the other side, and at least some of the exposure liquid LQ supplied via the supply ports 17 is recovered via the recovery ports 18. The exposure liquid LQ in the recovery passageway 19 recovered via the recovery ports 18 during the exposure sequence is discharged via the first discharge ports 21, and the gas G in the recovery passageway 19 is discharged via the second discharge ports 22.

Incidentally, during an exposure of the substrate P, there is a possibility that, for example, a substance (e.g., an organic substance such as the photosensitive material) produced by the substrate P will intermix with the exposure liquid LQ in the immersion space LS, or that a substance of the substrate P will elute into the exposure liquid LQ. That substance will function as foreign matter. In addition, along with the substance produced by the substrate P, foreign matter suspended in midair and the like might intermix with the exposure liquid LQ of the immersion space LS.

The liquid immersion member 3 is a member that contacts the exposure liquid LQ. In addition, because the first member 28 continues to contact the exposure liquid LQ at least during the exposure of the substrate P, if foreign matter intermixes with the exposure liquid LQ, then that foreign matter might adhere to the first member 28. For example, foreign matter might adhere to the lower surface 28B of the first member 28.

In addition, by virtue of the exposure liquid LQ in the immersion space LS, which is contaminated by foreign matter, being recovered via the recovery ports 18 and flowing through the recovery passageway 19, the foreign matter might adhere to at least part of, for example, the upper surface 28A and the inner surfaces of the holes 28H of the first member 28, the inner surface of the recovery passageway 19, and the surfaces (i.e., the upper surfaces 27A, the lower surfaces 27B, and the inner surfaces of the holes 27H) of the second members 27.

If the state wherein foreign matter is adhered to at least part of the surfaces of the liquid immersion member 3—including the lower surface 14, the inner surface of the recovery passageway 19, the surfaces of the first member 28, and the surfaces of the second members 27—is left as is, then, for example, that foreign matter might adhere to the substrate P during an exposure, or the exposure liquid LQ supplied via the supply ports 17 might become contaminated. In addition, if the lower surface 14 becomes contaminated, then there is also a possibility that, for example, the immersion space LS will no longer be able to be formed satisfactorily. As a result, exposure failures might occur.

Accordingly, in the present embodiment, the cleaning sequence (i.e., the step SP2) is performed wherein at least part of the liquid immersion member 3 is cleaned with a prescribed timing.

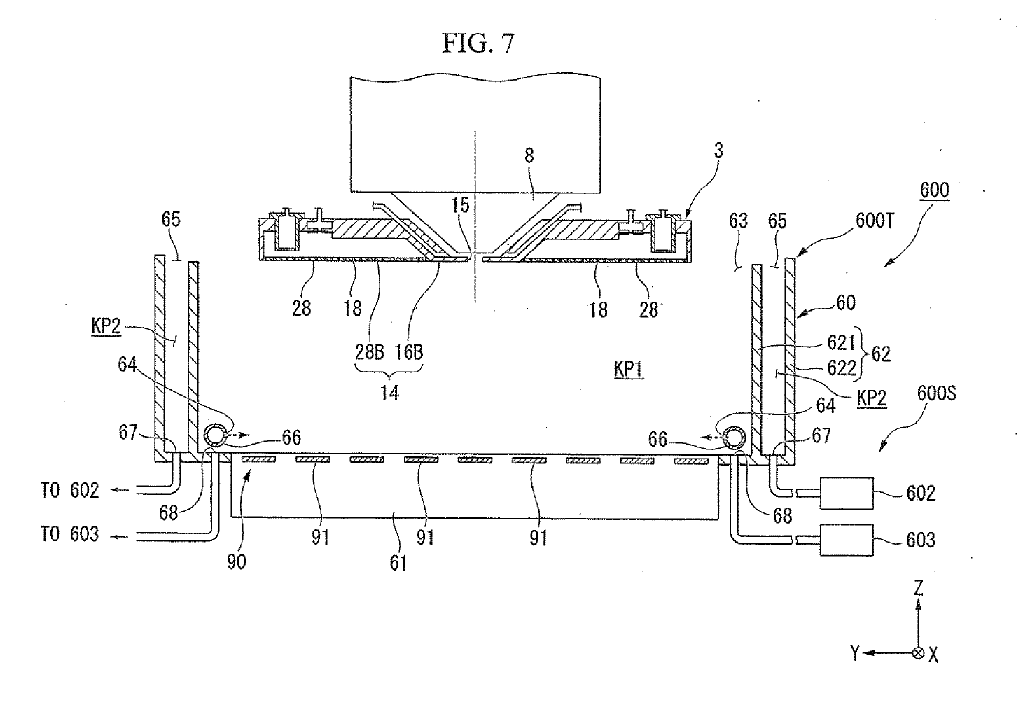

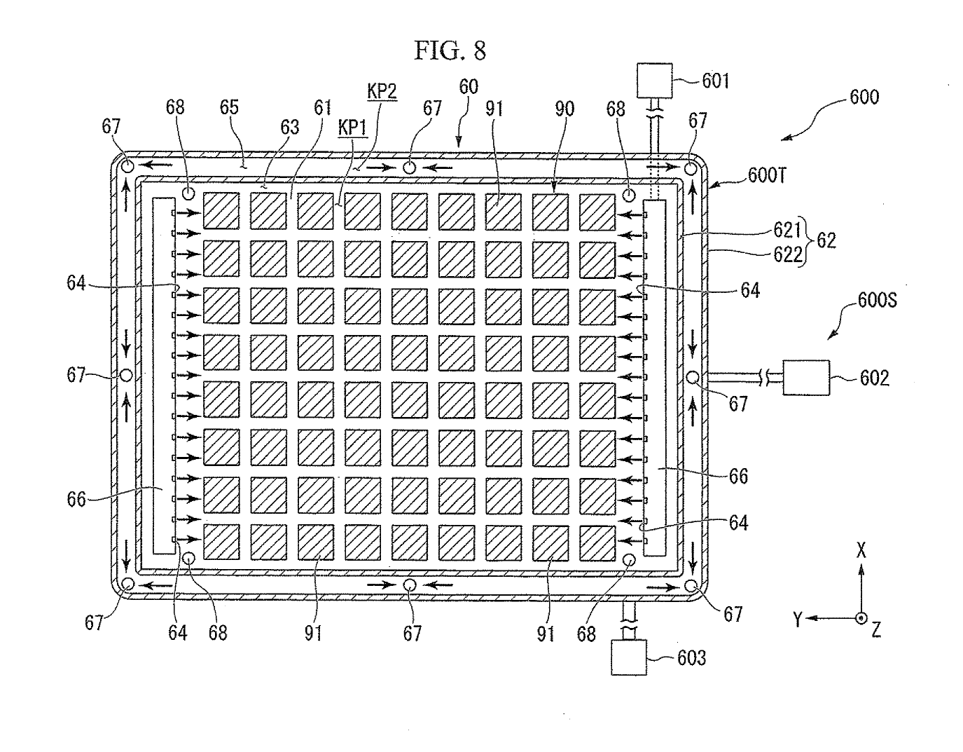

In the present embodiment, a cleaning process is performed that cleans the liquid immersion member 3 using a cleaning apparatus 600, which comprises a cleaning tool 600T. FIG. 7 is a partial side cross sectional view of the cleaning tool 600T according to the present embodiment, and FIG. 8 is a diagram of the cleaning tool 600T, viewed from above. The cleaning tool 600T is capable of being disposed at a position at which it opposes the recovery ports 18 of the liquid immersion member 3. In the present embodiment, after the exposure liquid LQ that forms the immersion space LS is substantially completely eliminated, the cleaning sequence is started and the cleaning tool 600T is disposed at a position at which it opposes the recovery ports 18 of the liquid immersion member 3.

In FIG. 7 and FIG. 8, the cleaning apparatus 600 comprises the cleaning tool 600T and a liquid system 600S. The liquid system 600S comprises a supply apparatus 601, which supplies the liquid (i.e., the first cleaning liquid LC1, the second cleaning liquid LC2, or the rinsing liquid LH, or any combination thereof) to the cleaning tool 600T, and recovery apparatuses 602, 603, which recover the liquid from the cleaning tool 600T.

The cleaning tool 600T comprises a holding member 60, which is capable of holding the liquid. In addition, in the present embodiment, the cleaning tool 600T comprises an ultrasonic wave generating apparatus 90, which is capable of imparting vibration to the liquid. Furthermore, the cleaning tool 600T may comprise a cover member that is capable of covering the opening 15 of the liquid immersion member 3.

The holding member 60 comprises a plate shaped base member 61 and a sidewall member 62, which is connected to side surfaces of and extends upward from the base member 61.

In the present embodiment, the sidewall member 62 comprises a first sidewall part 621, which forms a space KP1 that is capable of holding the liquid, and a second sidewall part 622, which is disposed around the first sidewall part 621 and forms a space KP2 that is capable of holding the liquid between itself and the first sidewall part 621. The space KP1 is defined by the base member 61 and the first sidewall part 621.

In addition, the holding member 60 has an opening 63, which is defined by the upper end of the first sidewall part 621. The opening 63 is larger than the liquid immersion member 3. During the cleaning of the liquid immersion member 3, the liquid immersion member 3 is disposed on the inner side of the opening 63.

In addition, the cleaning tool 600T has supply ports 64, which supply the liquid to the space between the liquid immersion member 3 and the holding member 60, and a recovery port 65, which recovers the liquid.

In the present embodiment, the cleaning tool 600T has piping members 66, which are disposed in the space KP1. The supply ports 64 are formed in the piping members 66. In the present embodiment, one of the piping members 66 is formed on the outer side of the +Y side edge of the upper surface of the base member 61 and another of the piping members 66 is formed on the outer side of the −Y side edge of the upper surface of the base member 61. Each of the piping members 66 is long in the X axial directions.

Each of the piping members 66 has a plurality of holes that connects the internal space and the external space (i.e., the space KP1) of that piping member 66. The plurality of holes in each of the piping members 66 is formed in the X axial directions. The supply ports 64 are disposed at the end of the holes that face the space KP1. The supply ports 64 supply the liquid toward the center of the space KP1.

The recovery port 65 is defined by the upper end of the first sidewall part 621 and the upper end of the second sidewall part 622. In the present embodiment, the recovery port 65 is provided annularly (in a rectangular annular shape) such that it surrounds the upper end of the first sidewall part 621. The recovery port 65 recovers the liquid that overflows from the upper end of the first sidewall part 621. The liquid in the space KP1 that overflows from the upper end of the first sidewall part 621 is recovered via the recovery port 65 and flows therethrough into the space KP2.

Discharge ports 67 are formed at a bottom part of the space KP2. In the present embodiment, the discharge ports 67 are smaller than the recovery port 65. The plurality of the discharge ports 67 is disposed at the bottom part of the space KP2. The discharge ports 67 discharge from the space KP2 the liquid that was recovered via the recovery port 65 and is present in the space KP2.

Discharge ports 68 are formed at a bottom part of the space KP1. A plurality of the discharge ports 68 is disposed at the bottom part of the space KP1. The discharge ports 68 are capable of discharging from the space KP1 the liquid present in the space KP1.

The ultrasonic wave generating apparatus 90 comprises oscillators 91, which are disposed on the upper surface of the base member 61 and generate ultrasonic vibration of a prescribed frequency. In the present embodiment, the plurality of the oscillators 91 is disposed on the upper surface of the base member 61. Each of the oscillators 91 is disposed such that it faces the space KP1. Each of the oscillators 91 may be, for example, a piezoelectric device and is driven by electric power supplied from a power supply apparatus.

The supply ports 64 are connected to the supply apparatus 601 via a passageway. In the present embodiment, the supply apparatus 601 is capable of supplying multiple types of liquid. In the present embodiment, the supply apparatus 601 is capable of supplying the cleaning liquids LC (LC1, LC2) and the rinsing liquid LH. In the present embodiment, the cleaning liquids LC include the first cleaning liquid LC1 and the second cleaning liquid LC2.

The discharge ports 67 are connected to the recovery apparatus 602 via a passageway. The recovery apparatus 602 is capable of suctioning, for example, the liquid. The liquid is discharged from the space KP2 via the discharge ports 67 by the operation of the recovery apparatus 602. Stopping the operation of the recovery apparatus 602 causes the liquid to be no longer discharged from the space KP2 via the discharge ports 67. Furthermore, the recovery apparatus 602 does not have to be capable of suctioning the liquid. For example, the liquid may be discharged to the recovery apparatus 602 via the discharge ports 67 by the action of gravity.

The discharge ports 68 are connected to the recovery apparatus 603 via a passageway. The recovery apparatus 603 is capable of suctioning, for example, the liquid. The liquid is discharged from the space KP1 via the discharge ports 68 by the operation of the recovery apparatus 603. Stopping the operation of the recovery apparatus 603 causes the liquid to be no longer discharged from the space KP1 via the discharge ports 68. Furthermore, the recovery apparatus 603 does not have to be capable of suctioning the liquid. For example, the liquid may be discharged to the recovery apparatus 603 via the discharge ports 68 by the action of gravity.

The text below explains one example of the cleaning sequence for cleaning the liquid immersion member 3 using the cleaning apparatus 600.

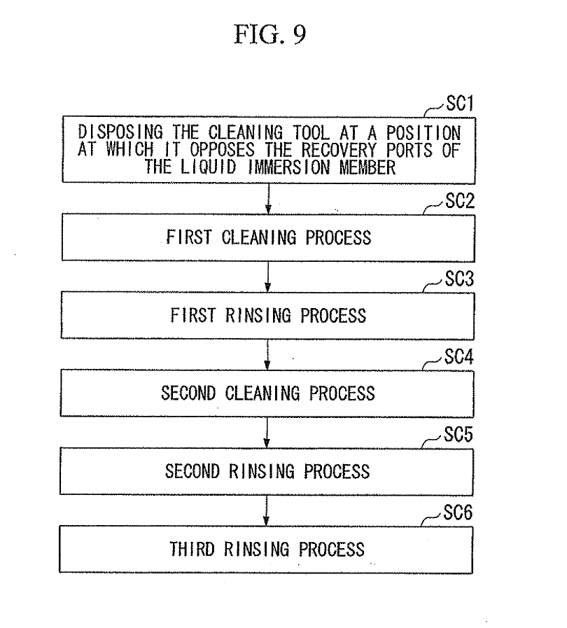

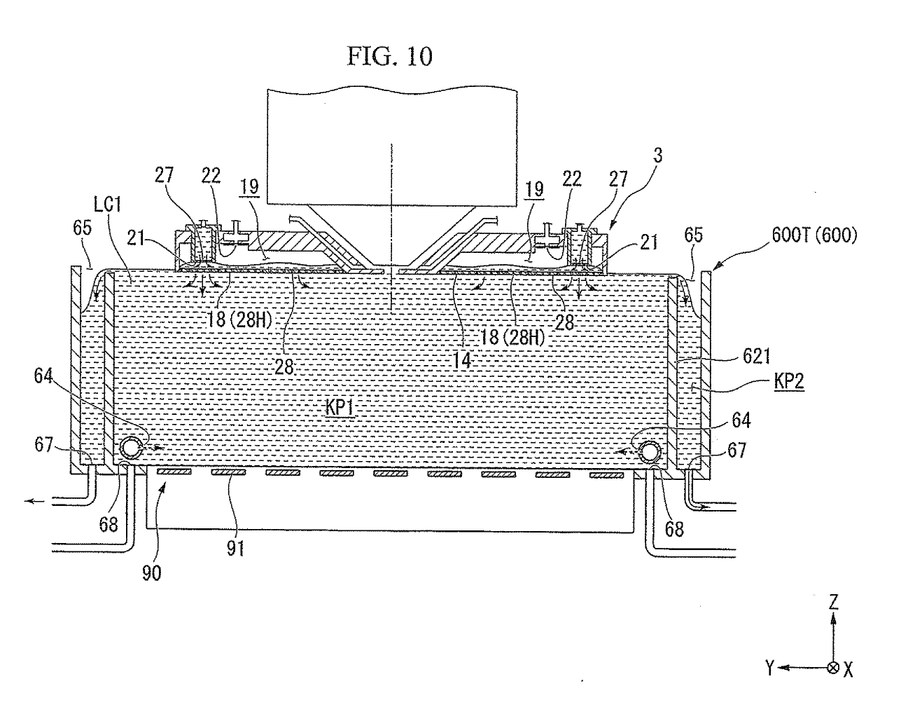

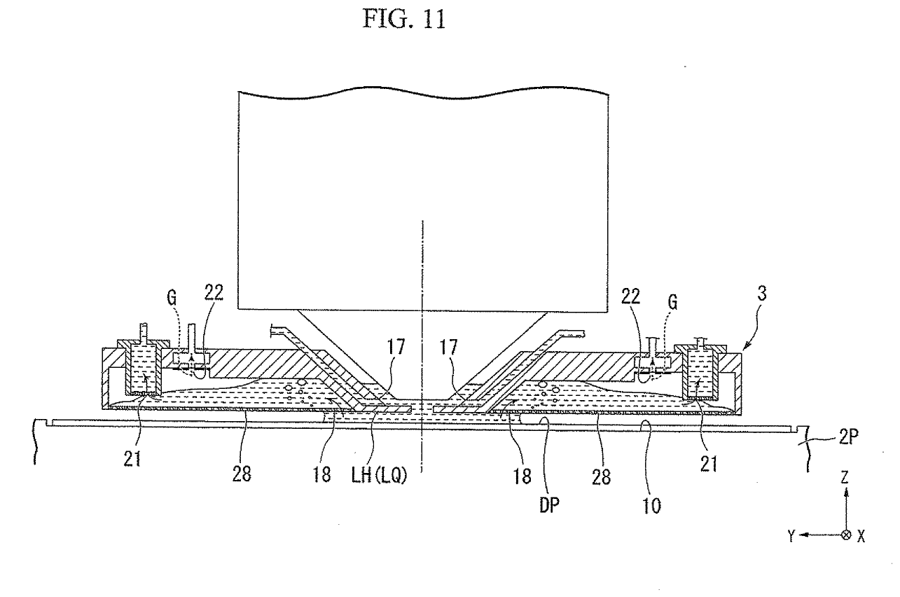

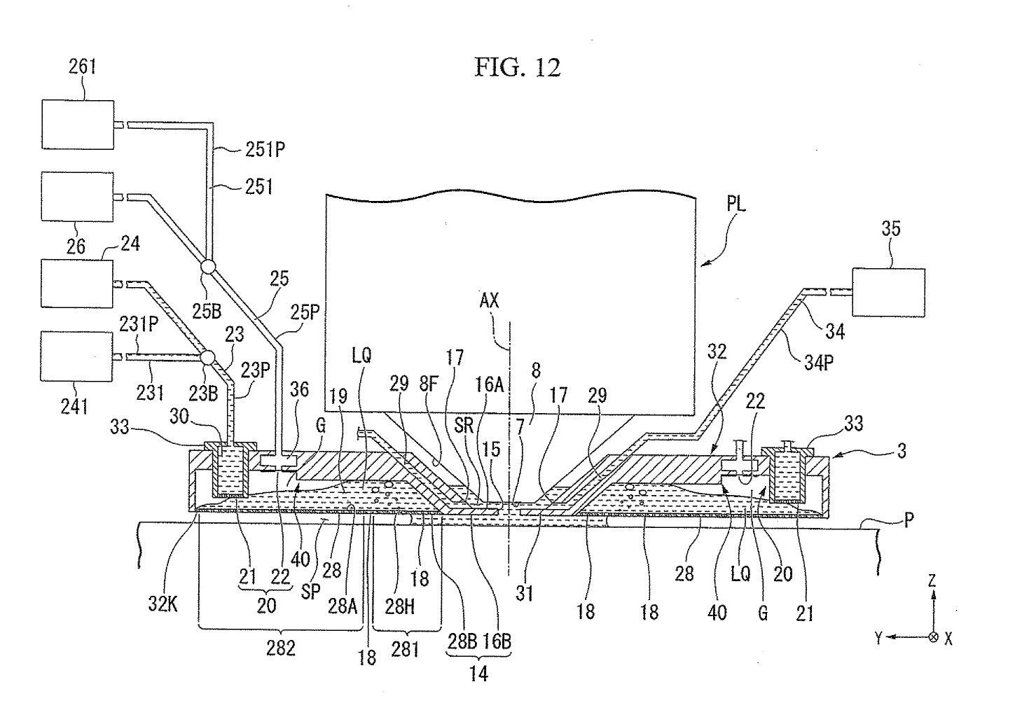

FIG. 9 is a flow chart that shows one example of the cleaning sequence according to the present embodiment, and FIG. 10 and FIG. 11 are schematic drawings that show one example of the cleaning sequence according to the present embodiment.

The cleaning sequence according to the present embodiment comprises: a process (i.e., a step SC1) wherein the cleaning tool 600T (i.e., the cleaning apparatus 600) is loaded into the exposure apparatus EX and disposed at a position at which it opposes the recovery ports 18 of the liquid immersion member 3; a process (i.e., a step SC2) wherein the first cleaning liquid LC1 is supplied to the recovery passageway 19 of the liquid immersion member 3 and thereby at least part of the liquid immersion member 3 is cleaned; a process (i.e., a step SC3) wherein the rinsing liquid LH is supplied to the recovery passageway 19; a process (i.e., a step SC4) wherein the second cleaning liquid LC2 is supplied to the recovery passageway 19 and thereby at least part of the liquid immersion member 3 is cleaned; a process (i.e., a step SC5) wherein the rinsing liquid LH is supplied to the recovery passageway 19; and a process (i.e., a step SC6) wherein the liquid immersion member 3 and the dummy substrate DP held by the substrate stage 2P (i.e., the substrate holding part 10) are caused to be opposed and the rinsing liquid LH is supplied to the recovery passageway 19.

In the present embodiment, at least some of the first cleaning liquid LC1, the second cleaning liquid LC2, or the rinsing liquid LH, or any combination thereof, supplied to the recovery passageway 19 is recovered via the recovery ports 18 of the liquid immersion member 3 and then via the recovery port 65 of the cleaning tool 600T.

In the explanation below, the cleaning process that uses the first cleaning liquid LC1 (i.e., the step SC2) is called a first cleaning process where appropriate, and the cleaning process that uses the second cleaning liquid LC2 (i.e., the step SC4) is called a second cleaning process where appropriate.

In addition, in the explanation below, the process wherein the rinsing liquid LH is supplied to a member, such as the liquid immersion member 3, that was cleaned using the cleaning liquids LC (LC1, LC2) is called a rinsing process where appropriate. The rinsing process includes a process that supplies the rinsing liquid LH to a member and then eliminates the cleaning liquids LC (LC1, LC2) remaining on that member by rinsing that member.

In addition, in the explanation below, the rinsing process that is performed after the first cleaning process (i.e., the step SC3) is called a first rinsing process where appropriate, the rinsing process that is performed after the second cleaning process (i.e., the step SC5) is called a second rinsing process where appropriate, and the rinsing process that is performed after the second rinsing process (i.e., the step SC6) is called a third rinsing process where appropriate.

An alkaline liquid, for example, may be used as the first cleaning liquid LC1. Namely, an alkaline solution that contains a prescribed substance may be used as the first cleaning liquid LC1. For example, the prescribed substance that the first cleaning liquid LC1 contains may be, for example, tetramethylammonium hydroxide (TMAH). In addition, an alkaline aqueous solution may be used as the first cleaning liquid LC1.

An acidic liquid, for example, may be used as the second cleaning liquid LC2. Namely, an acidic solution that contains a prescribed substance may be used as the second cleaning liquid LC2. The prescribed substance that the second cleaning liquid LC2 contains may be, for example, hydrogen peroxide. In addition, an acidic aqueous solution may be used as the second cleaning liquid LC2.

In addition, the first cleaning liquid LC1 and the rinsing liquid LH may be the same type of liquid. In addition, the second cleaning liquid LC2 and the rinsing liquid LH may be the same type of liquid.

In the present embodiment, an aqueous solution of tetramethylammonium hydroxide (TMAH) is used as the first cleaning liquid LC1. An aqueous solution of hydrogen peroxide (i.e., aqueous hydrogen peroxide) is used as the second cleaning liquid LC2. The exposure liquid LQ is used as the rinsing liquid LH. Namely, in the present embodiment, water (i.e., pure water) is used as the rinsing liquid LH. In the present embodiment, the abovementioned same type of liquid that is used as the first cleaning liquid LC1, the second cleaning liquid LC2, and the rinsing liquid LH may be water.

Furthermore, the alkaline solution used as the first cleaning liquid LC1 is not limited to tetramethylammonium hydroxide, and may be an inorganic alkaline solution of sodium hydroxide, potassium hydroxide, and the like, or may be an organic alkaline solution of trimethyl(2-hydroxyethyl)ammonium hydroxide and the like. Furthermore, aqueous ammonia may be used as the first cleaning liquid LC1.

Furthermore, the second cleaning liquid LC2 may be a solution of buffered hydrofluoric acid. In addition, the second cleaning liquid LC2 may be a solution that contains buffered hydrofluoric acid and hydrogen peroxide. Buffered hydrofluoric acid is a mixture of hydrofluoric acid and ammonium fluoride. The mixing ratio may be in the range of 5:1 to 2000:1 as calculated by the volumetric ratio of a 40 wt % solution of ammonium fluoride to 50 wt % of hydrofluoric acid. In addition, the mixing ratio of the buffered hydrofluoric acid to the hydrogen peroxide may be in the range of 0.8:1 to 55:1 as calculated by the weight ratio of the hydrogen peroxide to the hydrofluoric acid. The second cleaning liquid LC2 may even be an ozone liquid that contains ozone. Of course, it may be a solution that contains hydrogen peroxide and ozone.

Furthermore, the first cleaning liquid LC1 or the second cleaning liquid LC2, or both, may be an alcohol. For example, the first cleaning liquid LC1 or the second cleaning liquid LC2, or both, may be ethanol, isopropyl alcohol (IPA), or pentanol, or any combination thereof.

In addition, the abovementioned same type of liquid used as the first cleaning liquid LC1 and the second cleaning liquid LC2 may be, for example, an alcohol.

In addition, a rinsing liquid other than the rinsing liquid LH may be used in at least one of the following processes: the first rinsing process, the second rinsing process, and the third rinsing process.

In the cleaning sequence, first, the cleaning tool 600T (i.e., the cleaning apparatus 600) is loaded into the exposure apparatus EX (i.e., the step SC1). The cleaning tool 600T is capable of being loaded into and unloaded from the exposure apparatus EX. In the present embodiment, the cleaning tool 600T (i.e., the cleaning apparatus 600) is capable of passing through the openings 101K of the chamber member 101. The cleaning tool 600T is capable of being loaded into and unloaded from the internal space CS formed by the chamber member 101 of the exposure apparatus EX. As shown in FIG. 7, the cleaning tool 600T loaded into the internal space CS is disposed at a position at which it opposes the recovery ports 18 of the liquid immersion member 3. Inside the exposure apparatus EX, the cleaning tool 600T is disposed below (i.e., on the −Z side of) the liquid immersion member 3.

Furthermore, the loading of the cleaning tool 600T into the exposure apparatus EX may be performed by, for example, an operator or the transport apparatus.

After the liquid immersion member 3 and the cleaning tool 600T have been caused to oppose one another such that the liquid immersion member 3 is disposed in the opening 63 of the cleaning tool 600T, the first cleaning liquid LC1 is supplied to the recovery passageway 19.

In the present embodiment, as shown in FIG. 10, the first cleaning liquid LC1 is supplied to the recovery passageway 19 via the first discharge ports 21. As discussed above, in the present embodiment, the supply apparatus 241, which is capable of supplying the cleaning liquids LC (LC1, LC2) and the rinsing liquid LH, is connected to the passageway 23. Furthermore, a supply apparatus that supplies the cleaning liquids LC (LC1, LC2) and a supply apparatus that supplies the rinsing liquid LH may be separately provided. In addition, a supply apparatus that supplies the first cleaning liquid LC1 and a supply apparatus that supplies the second cleaning liquid LC2 may be separately provided. In the first cleaning process, the control apparatus 4 delivers the first cleaning liquid LC1 from the supply apparatus 241. The control apparatus 4 controls the passageway switching mechanism 23B such that the first cleaning liquid LC1 delivered from the supply apparatus 241 is supplied to the first discharge ports 21. Thereby, the first cleaning liquid LC1 delivered from the supply apparatus 241 is supplied to the first discharge ports 21 via the passageway 231 and the passageway 23. The first discharge ports 21 supply the first cleaning liquid LC1 from the supply apparatus 241 to the recovery passageway 19.

Furthermore, when the first cleaning liquid LC1 is being supplied to the recovery passageway 19 via the first discharge ports 21, the fluid discharge operation via the second discharge ports 22 is stopped. Namely, in the present embodiment, when the first cleaning liquid LC1 is being supplied to the recovery passageway 19 via the first discharge ports 21, the second discharge ports 22 do not suction the fluid (i.e., the fluid containing the gas G or the first cleaning liquid LC1, or both).

The first cleaning liquid LC1 from the supply apparatus 241 contacts at least part of the surfaces of the second members 27. Namely, the first cleaning liquid LC1 from the supply apparatus 241 contacts at least part of the upper surfaces 27A, the inner surfaces of the holes 27H, and the lower surfaces 27B of the second members 27. Thereby, the second members 27 are cleaned by the first cleaning liquid LC1.

In addition, at least some of the first cleaning liquid LC1 supplied to the recovery passageway 19 via the first discharge ports 21 contacts the inner surface of the recovery passageway 19. Thereby, at least part of the inner surface of the recovery passageway 19 is cleaned by the first cleaning liquid LC1.

In addition, at least some of the first cleaning liquid LC1 supplied to the recovery passageway 19 via the first discharge ports 21 contacts at least part of the surfaces of the first member 28. Namely, the first cleaning liquid LC1 from the first discharge ports 21 contacts at least part of the upper surface 28A, the inner surfaces of the holes 28H, and the lower surface 28B of the first member 28. Thereby, the first member 28 is cleaned by the first cleaning liquid LC1.

In addition, at least some of the first cleaning liquid LC1 supplied to the recovery passageway 19 via the first discharge ports 21 flows to the cleaning tool 600T via the holes 28H (i.e., the recovery ports 18) of the first member 28. In other words, the first cleaning liquid LC1 is discharged from the recovery passageway 19 via the recovery ports 18 to the space KP1, which the lower surface 14 of the liquid immersion member 3 faces. In the present embodiment, the cleaning tool 600T is disposed below the liquid immersion member 3 and at least some of the first cleaning liquid LC1 in the recovery passageway 19 flows by the action of gravity to the space below the liquid immersion member 3 via the holes 28H (i.e., the recovery ports 18). The cleaning tool 600T contains the first cleaning liquid LC1 that flows from the recovery ports 18 of the liquid immersion member 3 into the space KP1.

Furthermore, the first cleaning liquid LC1 may be pushed out of the recovery passageway 19 via the recovery ports 18. For example, in the state wherein the recovery passageway 19 is filled with the first cleaning liquid LC1, the first cleaning liquid LC1 may flow from the recovery passageway 19 to the cleaning tool 600T by virtue of the first cleaning liquid LC1 continuing to be supplied to the recovery passageway 19.

By virtue of the first cleaning liquid LC1 continuing to be supplied via the first discharge ports 21 and the first cleaning liquid LC1 being supplied to the space KP1 of the cleaning tool 600T via the recovery ports 18, the space KP1 is filled with the first cleaning liquid LC1. The first cleaning liquid LC1 is held between the liquid immersion member 3 and the cleaning tool 600T. The first cleaning liquid LC1 held between the liquid immersion member 3 and the cleaning tool 600T contacts at least part of the lower surface 14 of the liquid immersion member 3.

Furthermore, when the first cleaning liquid LC1 is flowing from the recovery passageway 19 to the space KP1 via the recovery ports 18, the operation of discharging the first cleaning liquid LC1 via the discharge ports 68 is not performed. Furthermore, the operation of discharging the first cleaning liquid LC1 via the discharge ports 68 may be performed.

In the state wherein the space KP1 is filled with the first cleaning liquid LC1, if the first cleaning liquid LC1 continues to flow from the recovery passageway 19 to the space KP1 via the recovery ports 18, then at least some of the first cleaning liquid LC1 in the space KP1 will overflow the first sidewall part 621. The first cleaning liquid LC1 that overflows the first sidewall part 621 is recovered via the recovery port 65.

Thus, in the present embodiment, the first cleaning liquid LC1 supplied to the recovery passageway 19 is recovered via the recovery ports 18 and then via the recovery port 65 of the cleaning tool 600T.

The first cleaning liquid LC1 recovered via the recovery port 65 flows therethrough into the space KP2. The first cleaning liquid LC1 is discharged from the space KP2 via the discharge ports 67. In the present embodiment, the cleaning apparatus 600 recovers (i.e., discharges) the first cleaning liquid LC1 via the recovery port 65 (i.e., the discharge ports 67) in parallel with discharging the first cleaning liquid LC1 to the space KP1 via the recovery ports 18. In other words, the cleaning apparatus 600 recovers (i.e., discharges) the first cleaning liquid LC1 via the recovery port 65 (i.e., the discharge ports 67) in parallel with the supply of the first cleaning liquid LC1 to the recovery passageway 19 via the first discharge ports 21.

Furthermore, the first cleaning liquid LC1 may be supplied via the supply ports 64 of the cleaning tool 600T in parallel with the supply of the first cleaning liquid LC1 via the first discharge ports 21. Furthermore, the same type or different types of the first cleaning liquid LC1 may be supplied via the first discharge ports 21 and the supply ports 64. For example, both the first cleaning liquid LC1 supplied via the first discharge ports 21 and the first cleaning liquid LC1 supplied via the supply ports 64 may be tetramethylammonium hydroxide; alternatively, the first cleaning liquid LC1 supplied via the first discharge ports 21 may be tetramethylammonium hydroxide and the first cleaning liquid LC1 supplied via the supply ports 64 may be aqueous ammonia.

After the supply of the first cleaning liquid LC1 via the first discharge ports 21 (i.e., the recovery ports 18) and the recovery of the first cleaning liquid LC1 via the recovery port 65 (i.e., the discharge ports 67) have been performed for a prescribed time, the supply of the first cleaning liquid LC1 via the first discharge ports 21 (i.e., the recovery ports 18) is stopped and the first cleaning liquid LC1 is discharged from the space KP1 via the discharge ports 68. Thereby, the first cleaning process (i.e., the step SC2) ends. Furthermore, the first cleaning process may end with the first cleaning liquid LC1 remaining as is in the space KP1.

Furthermore, in the first cleaning process, the fluid discharge operation via the second discharge ports 22 may be performed. For example, the operation of discharging the fluid (i.e., the fluid containing the first cleaning liquid LC1 or the gas G, or both) from the recovery passageway 19 via the second discharge ports 22 may be performed in parallel with at least part of the operation of supplying the first cleaning liquid LC1 via the first discharge ports 21.

In addition, in the first cleaning process, the discharge (i.e., the recovery) of the first cleaning liquid LC1 present in the recovery passageway 19 may be performed via the first discharge ports 21 by the operation of the first discharge apparatus 24. For example, the first cleaning liquid LC1 may be discharged (i.e., recovered) from the recovery passageway 19 via the first discharge ports 21 after the supply of the first cleaning liquid LC1 is stopped. In such a case, at least some of the first cleaning liquid LC1 may be discharged from the space KP1 via the recovery ports 18 and then via the first discharge ports 21.

Next, the first rinsing process (i.e., the step SC3) is started. In the present embodiment, the first rinsing process includes the supplying of the rinsing liquid LH to the recovery passageway 19.

In the present embodiment, the rinsing liquid LH is supplied to the recovery passageway 19 via the first discharge ports 21. As discussed above, in the present embodiment, the supply apparatus 241 is capable of supplying the rinsing liquid LH. In the first rinsing process, the control apparatus 4 delivers the rinsing liquid LH from the supply apparatus 241. The control apparatus 4 controls the passageway switching mechanism 23B such that the rinsing liquid LH delivered from the supply apparatus 241 is supplied to the first discharge ports 21. Thereby, the rinsing liquid LH delivered from the supply apparatus 241 is supplied to the first discharge ports 21 via the passageway 231 and the passageway 23. The first discharge ports 21 supply the rinsing liquid LH from the supply apparatus 241 to the recovery passageway 19.

Furthermore, when the rinsing liquid LH is being supplied to the recovery passageway 19 via the first discharge ports 21, the fluid discharge operation via the second discharge ports 22 is stopped.

The rinsing liquid LH from the supply apparatus 241 contacts at least part of the surfaces of the second members 27. Namely, the rinsing liquid LH from the supply apparatus 241 contacts at least part of the upper surfaces 27A, the inner surfaces of the holes 27H, and the lower surfaces 27B of the second members 27. Thereby, at least some of the first cleaning liquid LC1 remaining on the surfaces of the second members 27 is eliminated by the rinsing liquid LH.

In addition, at least some of the rinsing liquid LH supplied to the recovery passageway 19 via the first discharge ports 21 contacts the inner surface of the recovery passageway 19. Thereby, at least some of the first cleaning liquid LC1 remaining on the inner surface of the recovery passageway 19 is eliminated by the rinsing liquid LH.

In addition, at least some of the rinsing liquid LH supplied to the recovery passageway 19 via the first discharge ports 21 contacts at least part of the surfaces of the first member 28. Namely, the rinsing liquid LH from the first discharge ports 21 contacts at least part of the upper surface 28A, the inner surfaces of the holes 28H, and the lower surface 28B of the first member 28. Thereby, at least some of the first cleaning liquid LC1 remaining on the surfaces of the first member 28 is eliminated by the rinsing liquid LH.

At least some of the rinsing liquid LH supplied to the recovery passageway 19 via the first discharge ports 21 flows via the holes 28H (i.e., the recovery ports 18) of the first member 28 to the cleaning tool 600T. The cleaning tool 600T contains, in the space KP1, the rinsing liquid LH that flowed from the recovery passageway 19 of the liquid immersion member 3.

Furthermore, in the present embodiment, although the rinsing liquid LH flows to the space KP1 of the cleaning tool 600T via the holes 28H (i.e., the recovery ports 18) by the action of gravity, the rinsing liquid LH may be pushed out of the recovery passageway 19 to the space KP1 via the recovery ports 18. For example, in the state wherein the recovery passageway 19 is filled with the rinsing liquid LH, the rinsing liquid LH may be discharged from the recovery passageway 19 to the cleaning tool 600T by virtue of the rinsing liquid LH continuing to be supplied to the recovery passageway 19.

By virtue of the rinsing liquid LH continuing to be supplied via the first discharge ports 21 and the rinsing liquid LH being supplied to the space KP1 of the cleaning tool 600T via the recovery ports 18, the space KP1 is filled with the rinsing liquid LH. The rinsing liquid LH is held between the liquid immersion member 3 and the cleaning tool 600T. The rinsing liquid LH held between the liquid immersion member 3 and the cleaning tool 600T contacts at least part of the lower surface 14 of the liquid immersion member 3.

Furthermore, when the rinsing liquid LH is being supplied from the recovery passageway 19 to the space KP1 via the recovery ports 18, the operation of discharging the rinsing liquid LH via the discharge ports 68 is not performed. Furthermore, the operation of discharging the rinsing liquid LH via the discharge ports 68 may be performed.

In the state wherein the space KP1 is filled with the rinsing liquid LH, if the rinsing liquid LH continues to flow to the space KP1 via the recovery ports 18, then at least some of the rinsing liquid LH in the space KP1 will overflow the first sidewall part 621. The rinsing liquid LH that overflows the first sidewall part 621 is recovered via the recovery port 65.

Thus, in the present embodiment, the rinsing liquid LH supplied to the recovery passageway 19 is recovered via the recovery ports 18 and then via the recovery port 65 of the cleaning tool 600T.

The rinsing liquid LH recovered via the recovery port 65 flows therethrough into the space KP2. The rinsing liquid LH is discharged from the space KP2 via the discharge ports 67. In the present embodiment, the cleaning apparatus 600 recovers (i.e., discharges) the rinsing liquid LH via the recovery port 65 (i.e., the discharge ports 67) in parallel with discharging the rinsing liquid LH to the space KP1 via the recovery ports 18. In other words, the cleaning apparatus 600 recovers (i.e., discharges) the rinsing liquid LH via the recovery port 65 (i.e., the discharge ports 67) in parallel with the supply of the rinsing liquid LH to the recovery passageway 19 via the first discharge ports 21.

Furthermore, the rinsing liquid LH may be supplied via the supply ports 64 of the cleaning tool 600T in parallel with the supply of the rinsing liquid LH via the first discharge ports 21. In that case, the rinsing liquid LH supplied via the first discharge ports 21 and the rinsing liquid LH supplied via the supply ports 64 may be of the same type or of different types.

After the supply of the rinsing liquid LH via the first discharge ports 21 (i.e., the recovery ports 18) and the recovery of the rinsing liquid LH via the recovery port 65 (i.e., the discharge ports 67) have been performed for a prescribed time, the supply of the rinsing liquid LH via the first discharge ports 21 (i.e., the recovery ports 18) is stopped and the rinsing liquid LH is discharged from the space KP1 via the discharge ports 68. Thereby, the first rinsing process (i.e., the step SC3) ends. Furthermore, the first rinsing process may end with the rinsing liquid LH remaining in the space KP1 as is.

Furthermore, in the first rinsing process, the fluid discharge operation via the second discharge ports 22 may be performed. For example, the operation of discharging the fluid (i.e., the fluid containing the rinsing liquid LH or the gas G, or both) from the recovery passageway 19 via the second discharge ports 22 may be performed in parallel with at least part of the operation of supplying the rinsing liquid LH via the first discharge ports 21.

In addition, in the first rinsing process, the discharge (i.e., the recovery) of the rinsing liquid LH present in the recovery passageway 19 may be performed via the first discharge ports 21 by the operation of the first discharge apparatus 24. For example, the rinsing liquid LH may be discharged (i.e., recovered) from the recovery passageway 19 via the first discharge ports 21 after the supply of the rinsing liquid LH is stopped. In such a case, at least some of the rinsing liquid LH may be discharged from the space KP1 via the recovery ports 18 and then via the first discharge ports 21.

Furthermore, when the first rinsing process is started, the supply of the rinsing liquid LH may be started without performing the operation, in the first cleaning process, of discharging the first cleaning liquid LC1 present in the space KP1 via the discharge ports 68. In that case, the first cleaning liquid LC1 is supplied from the space KP1 to the recovery passageway 19 via the first discharge ports 21 and is recovered via the recovery port 65 together with the rinsing liquid LH that flowed into the space KP1 via the recovery ports 18.

Furthermore, when the first rinsing process is started, the supply of the rinsing liquid LH may be started prior to the discharge of the first cleaning liquid LC1 from the space KP1 via the discharge ports 68, and subsequently the discharge of the first cleaning liquid LC1 via the discharge ports 68 may be performed for a prescribed time.

Next, the second cleaning process (i.e., the step SC4) is started. In the present embodiment, the second cleaning process includes the process of supplying the second cleaning liquid LC2 to the recovery passageway 19.

In the present embodiment, the second cleaning liquid LC2 is supplied to the recovery passageway 19 via the first discharge ports 21. As discussed above, in the present embodiment, the supply apparatus 241 is capable of supplying the second cleaning liquid LC2. In the second cleaning process, the control apparatus 4 delivers the second cleaning liquid LC2 from the supply apparatus 241. The second cleaning liquid LC2 delivered from the supply apparatus 241 is supplied to the first discharge ports 21 via the passageway 231 and the passageway 23. The first discharge ports 21 supply the second cleaning liquid LC2 from the supply apparatus 241 to the recovery passageway 19.

The second cleaning process that uses the second cleaning liquid LC2 may be performed in the same manner as the first cleaning process that uses the first cleaning liquid LC1. A detailed explanation of the second cleaning process is omitted.

The second cleaning process cleans at least part of the surfaces of the second members 27 with the second cleaning liquid LC2.

In addition, the second cleaning process cleans at least part of the inner surface of the recovery passageway 19 with the second cleaning liquid LC2.

In addition, the second cleaning process cleans at least part of the surfaces of the first member 28 with the second cleaning liquid LC2.

Furthermore, the second cleaning liquid LC2 may be supplied via the supply ports 64 of the cleaning tool 600T in parallel with the supply of the second cleaning liquid LC2 via the first discharge ports 21. In that case, the second cleaning liquid LC2 supplied via the first discharge ports 21 and the second cleaning liquid LC2 supplied via the supply ports 64 may be of the same type or of different types.

After the supply of the second cleaning liquid LC2 via the first discharge ports 21 (i.e., the recovery ports 18) and the recovery of the second cleaning liquid LC2 via the recovery port 65 (i.e., the discharge ports 67) have been performed for a prescribed time, the supply of the second cleaning liquid LC2 via the first discharge ports 21 (i.e., the recovery ports 18) is stopped and the second cleaning liquid LC2 is discharged from the space KP1 via the discharge ports 68. Thereby, the second cleaning process (i.e., the step SC4) ends. Furthermore, the second cleaning process may end with the second cleaning liquid LC2 remaining as is in the space KP1.

Furthermore, in the second cleaning process, the fluid discharge operation via the second discharge ports 22 may be performed. For example, the operation of discharging the fluid (i.e., the fluid containing the second cleaning liquid LC2 or the gas G, or both) from the recovery passageway 19 via the second discharge ports 22 may be performed in parallel with at least part of the operation of supplying the second cleaning liquid LC2 via the first discharge ports 21.

In addition, in the second cleaning process, the discharge (i.e., the recovery) of the second cleaning liquid LC2 present in the recovery passageway 19 may be performed via the first discharge ports 21 by the operation of the first discharge apparatus 24. For example, the second cleaning liquid LC2 may be discharged (i.e., recovered) from the recovery passageway 19 via the first discharge ports 21 after the supply of the second cleaning liquid LC2 is stopped. In such a case, at least some of the second cleaning liquid LC2 may be discharged from the space KP1 via the recovery ports 18 and then via the first discharge ports 21.

Furthermore, when the second cleaning process is to be started, the supply of the second cleaning liquid LC2 may be started in the state wherein at least some of the rinsing liquid LH remains in the space KP1. In that case, the rinsing liquid LH is supplied from the space KP1 to the recovery passageway 19 via the first discharge ports 21 and is recovered via the recovery port 65 together with the second cleaning liquid LC2 that flowed into the space KP1 via the recovery ports 18.

Furthermore, when the second cleaning process is to be started, the supply of the second cleaning liquid LC2 may be started prior to the discharge of the rinsing liquid LH from the space KP1 via the discharge ports 68, and subsequently the discharge of the rinsing liquid LH via the discharge ports 68 may be performed for a prescribed time.

Next, the second rinsing process (i.e., the step SC5) is started. In the present embodiment, the rinsing liquid LH is supplied to the recovery passageway 19 via the first discharge ports 21. The second rinsing process may be performed in the same manner as the first rinsing process discussed above. A detailed explanation of the second rinsing process is omitted. The second rinsing process eliminates the second cleaning liquid LC2 remaining on at least part of the surfaces of the liquid immersion member 3.

When the supply of the rinsing liquid LH via the first discharge ports 21 is stopped and the second rinsing process ends, the rinsing liquid LH is discharged from the space KP1 via the discharge ports 68 and from the space KP2 via the discharge ports 67. Thereby, the liquid no longer exists in the spaces KP1, KP2. Subsequently, the cleaning tool 600T (i.e., the cleaning apparatus 600) is unloaded from the exposure apparatus EX. The unloading of the cleaning tool 600T may be performed by, for example, an operator or a prescribed transport apparatus.

Furthermore, when the second rinsing process is to be started, the discharge (i.e., the recovery) of the rinsing liquid LH present in the recovery passageway 19 may be performed via the first discharge ports 21 by the operation of the first discharge apparatus 24. For example, the rinsing liquid LH may be discharged (i.e., recovered) from the recovery passageway 19 via the first discharge ports 21 after the supply of the rinsing liquid LH is stopped. In such a case, at least some of the rinsing liquid LH may be discharged from the space KP1 via the recovery ports 18 and then via the first discharge ports 21.

In the present embodiment, during at least part of the first cleaning process that uses the cleaning tool 600T (i.e., the step SC2), the first rinsing process (i.e., the step SC3), the second cleaning process (i.e., the step SC4), and the second rinsing process (i.e., the step SC5), the cleaning apparatus 600 imparts ultrasonic waves to the liquid (i.e., the first cleaning liquid LC1, the second cleaning liquid LC2, or the rinsing liquid LH, or any combination thereof) in the recovery passageway 19 and the space KP1, which contacts the liquid immersion member 3. Namely, in the state wherein the space KP1 is filled with the liquid, the cleaning apparatus 600 operates the ultrasonic wave generating apparatus 90 so as to cause the oscillators 91 to generate ultrasonic vibration. The liquid whereto the ultrasonic waves have been imparted contacts at least part of the liquid immersion member 3. Thereby, the cleaning effect or the rinsing effect, or both, can be strengthened.

Furthermore, the liquid (i.e., the first cleaning liquid LC1, the second cleaning liquid LC2, or the rinsing liquid LH, or any combination thereof) whereto the ultrasonic waves have been imparted may be supplied to the recovery passageway 19. For example, by disposing an oscillator in the piping member 23P (or the piping member 231P) that is capable of generating ultrasonic vibration and then operating that oscillator to impart ultrasonic waves to the liquid that flows through the passageway 23 (or the passageway 231), that liquid whereto the ultrasonic waves have been imparted may be supplied to the recovery passageway 19 via the first discharge ports 21. Furthermore, by operating an oscillator that is disposed at least partly in the liquid immersion member 3, ultrasonic waves may be imparted to the liquid supplied to the recovery passageway 19 via the first discharge ports 21. Furthermore, the ultrasonic wave generating apparatus 90 of the cleaning tool 600T may be omitted.

After the cleaning apparatus 600 has been unloaded, the dummy substrate DP held by the substrate stage 2P is disposed such that it opposes the liquid immersion member 3 as shown in FIG. 11. The dummy substrate DP is a substrate that tends not to release foreign matter more than the substrate P tends to. The dummy substrate DP is not used in the formation of the device pattern. In addition, there may be a function that traps foreign matter on the front surface of the dummy substrate DP. In this case, it is preferable that the front surface of the dummy substrate DP tends not to release the captured (i.e., adhered) foreign matter. In addition, in the present embodiment, the external shape and size of the dummy substrate DP are substantially the same as those of the substrate P. The substrate holding part 10 is capable of holding the dummy substrate DP. Furthermore, the external shape and size of the dummy substrate DP do not have to be the same as those of the substrate P.

The control apparatus 4 starts the third rinsing process (i.e., the step SC6) in the state wherein the liquid immersion member 3 and the dummy substrate DP are opposed. The third rinsing process includes the operation of supplying the rinsing liquid LH (i.e., the exposure liquid LQ) via the supply ports 17 of the liquid immersion member 3 in the state wherein the dummy substrate DP is disposed such that it opposes the liquid immersion member 3, and the operation of recovering, in parallel with the operation of supplying, the rinsing liquid LH via the recovery ports 18. Thereby, the liquid immersion member 3 is rinsed.

Furthermore, in the state wherein the immersion space LS is formed between the last optical element 8 and the liquid immersion member 3 on one side and the dummy substrate DP on the other side, the dummy substrate DP may be, but does not have to be, moved within the XY plane by controlling the substrate stage 2P.

Furthermore, the range of movement of the dummy substrate DP (i.e., the substrate stage 2P) with respect to the liquid immersion member 3 may be controlled such that the immersion space LS is formed only above the dummy substrate DP and such that the rinsing liquid LH in the immersion space LS does not contact the upper surface 2PF of the substrate stage 2P on the outer side of the dummy substrate DP; furthermore, the dummy substrate DP (i.e., the substrate stage 2P) may be moved such that the rinsing liquid LH contacts the upper surface 2PF of the substrate stage 2P.

The above step completes the cleaning sequence. After the cleaning sequence has ended, the exposure sequence discussed above, for example, may be started. According to the present embodiment as explained above, the liquid immersion member 3 can be cleaned satisfactorily. Accordingly, it is possible to prevent exposure failures from occurring and defective devices from being produced.

In addition, according to the present embodiment, at least part of the surfaces of the liquid immersion member 3—including the lower surface 14 of the liquid immersion member 3, the surfaces (i.e., the upper surface 28A, the lower surface 28B, or the inner surfaces of the holes 28H, or any combination thereof) of the first member 28, the inner surface of the recovery passageway 19, and the surfaces (i.e., the upper surfaces 27A, the lower surfaces 27B, or the inner surfaces of the holes 27H, or any combination thereof) of the second members 27—can be cleaned satisfactorily. In addition, the passageways connected to the liquid immersion member 3 can be cleaned.

Furthermore, in the present embodiment, it is given that the first cleaning liquid LC1, the second cleaning liquid LC2, and the rinsing liquid LH are supplied to the recovery passageway 19 via the first discharge ports 21, which face the recovery passageway 19; however, a supply port that faces the recovery passageway 19 and is different from the first discharge ports 21 and the second discharge ports 22 may be provided to the liquid immersion member 3, and the first cleaning liquid LC1, the second cleaning liquid LC2, or the rinsing liquid LH, or any combination thereof, may be supplied to the recovery passageway 19 via that supply port.

Furthermore, in the present embodiment, a liquid recovery port other than the recovery ports 18 may be provided to the liquid immersion member 3 such that the liquid recovery port faces the space KP1, and the liquid (i.e., the first cleaning liquid LC1, the second cleaning liquid LC2, or the rinsing liquid LH, or any combination thereof) that is supplied to the recovery passageway 19 via the first discharge ports 21 (or the second discharge ports 22) and flows to the space KP1 via the recovery ports 18 may be recovered via that liquid recovery port.

Furthermore, in the present embodiment, if the liquid is not supplied via the supply ports 64 of the cleaning tool 600T in any of the processes, namely, the first cleaning process, the second cleaning process, the first rinsing process, and the second rinsing process, then the supply apparatus 601 and the supply ports 64 can be omitted.

In addition, in the present embodiment, the first discharge ports 21 may be capable of supplying the gas G to the recovery passageway 19.

### Second Embodiment

A second embodiment will now be explained. In the explanation below, constituent parts that are identical or equivalent to those in the embodiment discussed above are assigned identical symbols, and the explanations thereof are therefore abbreviated or omitted.

FIG. 12 shows part of the exposure apparatus EX according to the second embodiment. In the present embodiment, as shown in FIG. 12, the second discharge ports 22 are capable of supplying the liquid (i.e., the first cleaning liquid LC1, the second cleaning liquid LC2, or the rinsing liquid LH, or any combination thereof) to the recovery passageway 19.

In FIG. 12, a supply apparatus 261, which is capable of supplying the liquid, is connected to the passageway 25 via a passageway 251, which is formed by a piping member 251P. The passageway 251 is connected to the passageway 25 via a passageway switching mechanism 25B, which comprises, for example, a valve mechanism. The supply apparatus 261 is capable of supplying the liquid to the second discharge ports 22 via the passageway 251 and the passageway 25. The second discharge ports 22 are capable of supplying the liquid from the supply apparatus 261 to the recovery passageway 19. When the liquid is being discharged from the recovery passageway 19 via the second discharge ports 22, the control apparatus 4 controls the passageway switching mechanism 25B such that the second discharge ports 22 are connected via the passageway 25 to the second discharge apparatus 26 and not to the supply apparatus 261. In the state wherein the second discharge ports 22 and the second discharge apparatus 26 are connected via the passageway 25 by the passageway switching mechanism 25B, the fluid is discharged from the recovery passageway 19 via the second discharge ports 22 by the operation of the second discharge apparatus 26. Moreover, when the liquid is being supplied to the recovery passageway 19 via the second discharge ports 22, the control apparatus 4 controls the passageway switching mechanism 25B such that the second discharge ports 22 are connected to the supply apparatus 261 via the passageway 25 and the passageway 251 and not to the second discharge apparatus 26. In the state wherein the passageway switching mechanism 25B connects the second discharge ports 22 and the supply apparatus 261 via the passageway 25 and the passageway 251, the liquid is supplied to the recovery passageway 19 via the second discharge ports 22 by the operation of the supply apparatus 261.

In the present embodiment, the liquid that is capable of being supplied via the second discharge ports 22 includes at least one of the following liquids: the cleaning liquids LC (LC1, LC2), which are for cleaning, for example, at least some of the members of the exposure apparatus EX; and the rinsing liquid LH, which is for eliminating any of the cleaning liquids LC that remain on those members. For example, the supply of the liquid via the second discharge ports 22 may be performed in parallel with at least part of the supply of the liquid via the first discharge ports 21. In that case, the liquid supplied via the first discharge ports 21 and the liquid supplied via the second discharge ports 22 may be of the same type or of different types.

Furthermore, in the present embodiment, an oscillator may be disposed in the piping member 25P (or the piping member 251P). The liquid, whereto the ultrasonic waves generated by the operation of the oscillator have been imparted, may be supplied to the recovery passageway 19 via the second discharge ports 22.

Furthermore, in the present embodiment, if the liquid is not supplied via the first discharge ports 21, then the supply apparatus 241 can be omitted.

Furthermore, in the present embodiment, a configuration may be adopted such that the gas G can be supplied via the second discharge ports 22. For example, the flow (i.e., the discharge) of the liquid from the recovery passageway 19 to the space SP may be promoted by supplying the gas G via the second discharge ports 22 in parallel with supplying the liquid via the first discharge ports 21.

Furthermore, in the present embodiment, one or more of the liquids, namely, the first cleaning liquid LC1, the second cleaning liquid LC2, or the rinsing liquid LH (e.g., the first cleaning liquid LC1 and the second cleaning liquid LC2), may be supplied via one of the kinds of ports, namely, the first discharge ports 21 or the second discharge ports 22, and the remainder (e.g., the rinsing liquid LH) may be supplied via the other kind of ports.

### Third Embodiment

A third embodiment will now be explained. In the explanation below, constituent parts that are identical or equivalent to those in the embodiments discussed above are assigned identical symbols, and the explanations thereof are therefore abbreviated or omitted.

In the third embodiment, the first cleaning liquid LC1, the second cleaning liquid LC2, or the rinsing liquid LH, or any combination thereof, is supplied to the recovery passageway 19 via the supply ports 64 of the cleaning tool 600T. In the present embodiment, the exposure apparatus EX comprises neither the supply apparatus 241 explained in the first embodiment nor the supply apparatus 261 explained in the second embodiment. Furthermore, the first cleaning liquid LC1, the second cleaning liquid LC2, and the rinsing liquid LH used in the present embodiment are the same liquids as those in the first embodiment.

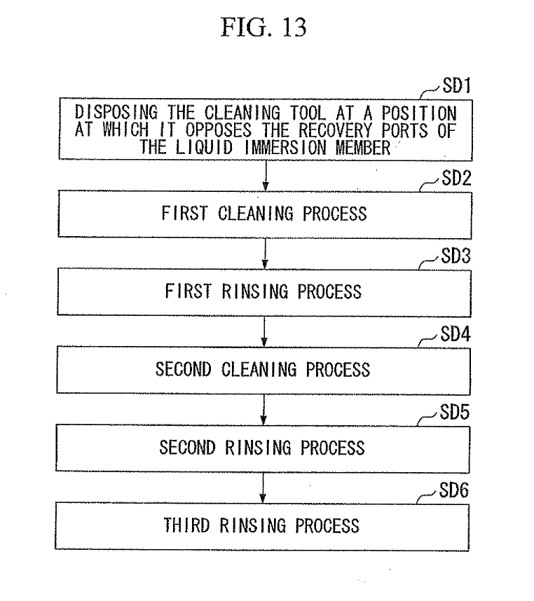

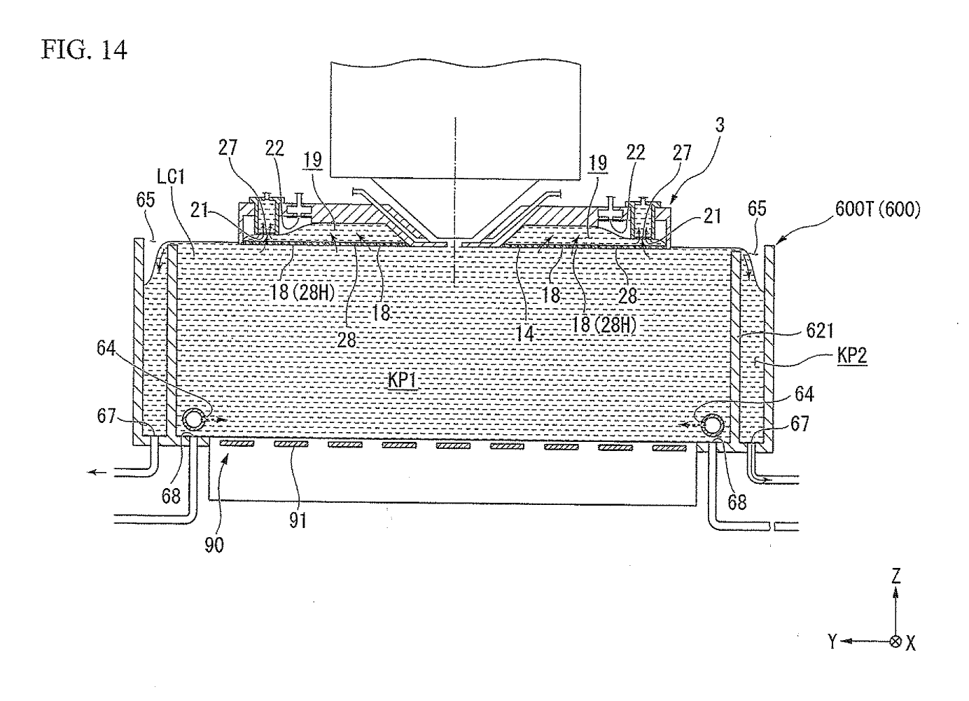

FIG. 13 is a flow chart that shows one example of the cleaning sequence according to the present embodiment, and FIG. 14 is a schematic drawing that shows one example of the cleaning sequence according to the present embodiment.

In the cleaning sequence, first, the cleaning tool 600T (i.e., the cleaning apparatus 600) is loaded into the exposure apparatus EX (i.e., a step SD1).

Next, the first cleaning process is started (i.e., a step SD2). In the present embodiment, the first cleaning liquid LC1 is supplied via the supply ports 64, which belong to the cleaning tool 600T. The first cleaning liquid LC1 supplied via the supply ports 64 of the cleaning tool 600T is supplied to the recovery passageway 19 via the recovery ports 18.

The cleaning apparatus 600 supplies the first cleaning liquid LC1 via the supply ports 64. By continuing the supply of the first cleaning liquid LC1 via the supply ports 64 and by supplying the first cleaning liquid LC1 to the space KP1 of the cleaning tool 600T, the space KP1 is filled with the first cleaning liquid LC1. The first cleaning liquid LC1 is held between the liquid immersion member 3 and the cleaning tool 600T. The first cleaning liquid LC1 held between the liquid immersion member 3 and the cleaning tool 600T contacts at least part of the lower surface 14 of the liquid immersion member 3.

The control apparatus 4 negatively pressurizes the recovery passageway 19. The control apparatus 4 discharges the fluid from the recovery passageway 19 via the second discharge ports 22 by operating the second discharge apparatus 26. The second discharge ports 22 discharge at least the gas G from the recovery passageway 19. Thereby, the pressure in the recovery passageway 19 decreases to a pressure lower than the pressure (e.g., atmospheric pressure) in the space KP1, which the lower surface 14 of the liquid immersion member 3 faces.

In the present embodiment, the first cleaning liquid LC1 is supplied via the supply ports 64 of the cleaning tool 600T in the state wherein the recovery passageway 19 has been negatively pressurized. The first cleaning liquid LC1 in the space KP1 that was supplied via the supply ports 64 and that contacts the first member 28 of the liquid immersion member 3 flows into the recovery passageway 19 via the recovery ports 18. Thereby, the first cleaning liquid LC1 supplied via the supply ports 64 is supplied to the recovery passageway 19 via the recovery ports 18.

At least some of the first cleaning liquid LC1 contacts at least part of the surfaces of the first member 28. Namely, the first cleaning liquid LC1 contacts at least part of the upper surface 28A, the inner surfaces of the holes 28H, and the lower surface 28B of the first member 28. Thereby, the first member 28 is cleaned by the first cleaning liquid LC1.

In addition, at least some of the first cleaning liquid LC1 contacts the inner surface of the recovery passageway 19. Thereby, at least part of the inner surface of the recovery passageway 19 is cleaned by the first cleaning liquid LC1.

In addition, at least some of the first cleaning liquid LC1 contacts at least part of the surfaces of the second members 27. Namely, the first cleaning liquid LC1 contacts at least part of the upper surfaces 27A, the inner surfaces of the holes 27H, and the lower surfaces 27B of the second members 27. Thereby, the second members 27 are cleaned by the first cleaning liquid LC1.

In the present embodiment, the control apparatus 4 performs the fluid discharge operation (i.e., a fluid recovery operation) via the first discharge ports 21 in parallel with at least part of the fluid discharge operation via the second discharge ports 22. Namely, the control apparatus 4 operates both the first discharge apparatus 24 and the second discharge apparatus 26. Thereby, at least some of the first cleaning liquid LC1 that flowed into the recovery passageway 19 via the recovery ports 18 is discharged (i.e., recovered) via the first discharge ports 21. In the present embodiment, substantially all of the first cleaning liquid LC1 that flows into the recovery passageway 19 is discharged via the first discharge ports 21. Furthermore, at least some of the first cleaning liquid LC1 may be discharged (i.e., recovered) from the recovery passageway 19 via the second discharge ports 22.

The first cleaning liquid LC1 discharged via the first discharge ports 21 is recovered via a member that constitutes at least part of the exposure apparatus EX, for example, the passageway 23 and the like.

Furthermore, when the first cleaning liquid LC1 is being supplied to the space KP1 via the supply ports 64, the discharge operation wherein the first cleaning liquid LC1 is discharged via the discharge ports 68 is not performed. Furthermore, the operation of discharging the first cleaning liquid LC1 via the discharge ports 68 may be performed.

Furthermore, if at least some of the first cleaning liquid LC1 in the space KP1 overflows the upper end of the first sidewall part 621, then the first cleaning liquid LC1 that does so is recovered via the recovery port 65. Furthermore, the first cleaning liquid LC1 may be recovered from the space KP1 via the recovery ports 18 so that the first cleaning liquid LC1 in the space KP1 does not overflow the upper end of the first sidewall part 621.

After the supply and the recovery of the first cleaning liquid LC1 have been performed for the prescribed time, the supply of the first cleaning liquid LC1 via the supply ports 64 is stopped and the recovery of the first cleaning liquid LC1 via the first discharge ports 21 or the second discharge ports 22, or both, is performed. Furthermore, the first cleaning liquid LC1 is discharged from the space KP1 of the cleaning tool 600T via the discharge ports 68. Thereby, the first cleaning process (i.e., the step SD2) ends. Furthermore, the first cleaning process may end in the state wherein the first cleaning liquid LC1 remains in the space KP1.

Next, the first rinsing process (i.e., a step SD3) is started. In the present embodiment, after the first cleaning liquid LC1 has been discharged from the space KP1 via the discharge ports 68, the supply of the rinsing liquid LH via the supply ports 64 is started. Furthermore, the supply of the rinsing liquid LH via the supply ports 64 may be started in the state wherein at least some of the first cleaning liquid LC1 remains in the space KP1.

In the present embodiment, the rinsing liquid LH supplied via the supply ports 64 of the cleaning tool 600T is supplied to the recovery passageway 19 via the recovery ports 18.

By continuing the supply of the rinsing liquid LH via the supply ports 64 and by supplying the rinsing liquid LH to the space KP1 of the cleaning tool 600T, the space KP1 is filled with the rinsing liquid LH. The rinsing liquid LH is held between the liquid immersion member 3 and the cleaning tool 600T. The rinsing liquid LH held between the liquid immersion member 3 and the cleaning tool 600T contacts at least part of the lower surface 14 of the liquid immersion member 3.

The control apparatus 4 negatively pressurizes the recovery passageway 19. The control apparatus 4 discharges the fluid from the recovery passageway 19 via the second discharge ports 22 by operating the second discharge apparatus 26. The second discharge ports 22 discharge at least the gas G from the recovery passageway 19. Thereby, the pressure in the recovery passageway 19 decreases to a pressure lower than the pressure (e.g., atmospheric pressure) in the space KP1, which the lower surface 14 of the liquid immersion member 3 faces.

In the present embodiment, the rinsing liquid LH is supplied via the supply ports 64 of the cleaning tool 600T in the state wherein the recovery passageway 19 has been negatively pressurized. The rinsing liquid LH in the space KP1 that was supplied via the supply ports 64 and that contacts the first member 28 of the liquid immersion member 3 flows into the recovery passageway 19 via the recovery ports 18. Thereby, the rinsing liquid LH that was supplied via the supply ports 64 is supplied via the recovery ports 18 to the recovery passageway 19.

At least some of the rinsing liquid LH contacts at least part of the surfaces of the first member 28. Namely, the rinsing liquid LH contacts at least part of the upper surface 28A, the inner surfaces of the holes 28H, and the lower surface 28B of the first member 28. Thereby, at least some of the first cleaning liquid LC1 remaining on the surfaces of the first member 28 is eliminated by the rinsing liquid LH.

In addition, at least some of the rinsing liquid LH contacts the inner surface of the recovery passageway 19. Thereby, at least some of the first cleaning liquid LC1 remaining on the inner surface of the recovery passageway 19 is eliminated by the rinsing liquid LH.

In addition, at least some of the rinsing liquid LH contacts at least part of the surfaces of the second members 27. Namely, the rinsing liquid LH contacts at least part of the upper surfaces 27A, the inner surfaces of the holes 27H, and the lower surfaces 27B of the second members 27. Thereby, at least some of the first cleaning liquid LC1 remaining on the surfaces of the second members 27 is eliminated by the rinsing liquid LH.

In the present embodiment, the control apparatus 4 performs the fluid discharge operation (i.e., a fluid recovery operation) via the first discharge ports 21 in parallel with at least part of the fluid discharge operation via the second discharge ports 22. Namely, the control apparatus 4 operates both the first discharge apparatus 24 and the second discharge apparatus 26. Thereby, at least some of the rinsing liquid LH that flows into the recovery passageway 19 via the recovery ports 18 is discharged (i.e., recovered) via the first discharge ports 21. In the present embodiment, substantially all of the rinsing liquid LH that flows into the recovery passageway 19 is discharged via the first discharge ports 21. Furthermore, at least some of the rinsing liquid LH may be discharged (i.e., recovered) from the recovery passageway 19 via the second discharge ports 22.

The rinsing liquid LH discharged via the first discharge ports 21 is recovered via a member that constitutes at least part of the exposure apparatus EX, for example, the passageway 23 and the like.

Furthermore, when the rinsing liquid LH is being supplied to the space KP1 via the supply ports 64, the operation of discharging the rinsing liquid LH via the discharge ports 68 is not performed. Furthermore, the operation of discharging the rinsing liquid LH via the discharge ports 68 may be performed.

Furthermore, if at least some of the rinsing liquid LH in the space KP1 overflows the upper end of the first sidewall part 621, then the rinsing liquid LH that does so is recovered via the recovery port 65. Furthermore, the rinsing liquid LH may be recovered from the space KP1 via the recovery ports 18 so that the rinsing liquid LH in the space KP1 does not overflow the upper end of the first sidewall part 621.

After the supply and the recovery of the rinsing liquid LH have been performed for the prescribed time, the supply of the rinsing liquid LH via the supply ports 64 is stopped and the recovery of the rinsing liquid LH via the first discharge ports 21 or the second discharge ports 22, or both, is performed. Furthermore, the rinsing liquid LH is discharged from the space KP1 of the cleaning tool 600T via the discharge ports 68. Thereby, the first rinsing process (i.e., the step SD3) ends. Furthermore, the first rinsing process may end in the state wherein the rinsing liquid LH remains in the space KP1.

Next, the second cleaning process (i.e., a step SD4) is started. In the present embodiment, the second cleaning liquid LC2 is supplied via the supply ports 64 of the cleaning tool 600T and then supplied to the recovery passageway 19 via the recovery ports 18.

In the present embodiment, the second cleaning process (i.e., the step SD4) may be performed in the same manner as the first cleaning process (i.e., the step SD2). A detailed explanation of the first cleaning process is omitted.

In the second cleaning process, at least some of the second cleaning liquid LC2 contacts at least part of the surfaces of the first member 28. Namely, the second cleaning liquid LC2 contacts at least part of the upper surface 28A, the inner surfaces of the holes 28H, and the lower surface 28B of the first member 28. Thereby, the first member 28 is cleaned by the second cleaning liquid LC2.

In addition, in the second cleaning process, at least some of the second cleaning liquid LC2 contacts the inner surface of the recovery passageway 19. Thereby, at least part of the inner surface of the recovery passageway 19 is cleaned by the second cleaning liquid LC2.

In addition, in the second cleaning process, at least some of the second cleaning liquid LC2 contacts at least part of the surfaces of the second members 27. Namely, the second cleaning liquid LC2 contacts at least part of the upper surfaces 27A, the inner surfaces of the holes 27H, and the lower surfaces 278 of the second members 27. Thereby, the second members 27 are cleaned by the second cleaning liquid LC2.

After the supply and the recovery of the second cleaning liquid LC2 have been performed for the prescribed time, the second cleaning process (i.e., the step SD4) ends.

Next, the second rinsing process (i.e., a step SD5) is started. In the present embodiment, the rinsing liquid LH is supplied via the supply ports 64 of the cleaning tool 600T and then supplied to the recovery passageway 19 via the recovery ports 18. The second rinsing process may be performed in the same manner as the first rinsing process discussed above. A detailed explanation of the second rinsing process is omitted.

The second rinsing process eliminates the second cleaning liquid LC2 remaining on at least part of the surfaces of the liquid immersion member 3. Namely, at least some of the second cleaning liquid LC2 remaining on the surfaces of the first member 28 is eliminated by the rinsing liquid LH. In addition, at least some of the second cleaning liquid LC2 remaining on the inner surface of the recovery passageway 19 is eliminated by the rinsing liquid LH. In addition, at least some of the second cleaning liquid LC2 remaining on the surfaces of the second members 27 is eliminated by the rinsing liquid LH.

After the supply and the recovery of the rinsing liquid LH have been performed for the prescribed time, the second rinsing process (i.e., the step SD5) ends, whereupon the cleaning tool 600T is unloaded from the exposure apparatus EX.

In the present embodiment, during at least part of the first cleaning process (i.e., the step SD2) that uses the cleaning tool 600T, the first rinsing process (i.e., the step SD3), the second cleaning process (i.e., the step SD4), and the second rinsing process (i.e., the step SD5), the cleaning apparatus 600 imparts ultrasonic waves to the liquid (i.e., the first cleaning liquid LC1, the second cleaning liquid LC2, or the rinsing liquid LH, or any combination thereof) in the space KP1, which contacts the liquid immersion member 3. Namely, in the state wherein the space KP1 is filled with the liquid, the cleaning apparatus 600 operates the ultrasonic wave generating apparatus 90, which uses the oscillators 91 to generate ultrasonic vibration. The liquid whereto the ultrasonic waves have been imparted contacts the liquid immersion member 3. Thereby, the cleaning effect or the rinsing effect, or both, can be strengthened.

Furthermore, when the liquid is being supplied to the recovery passageway 19 via the supply ports 64 and then via the recovery ports 18 during the first cleaning process (i.e., the step SD2), the first rinsing process (i.e., the step SD3), the second cleaning process (i.e., the step SD4), or the second rinsing process (i.e., the step SD5), or any combination thereof, the fluid discharge operation may be performed via either just the first discharge ports 21 or just the second discharge ports 22.

In addition, the liquid does not have to be discharged from either the first discharge ports 21 or the second discharge ports 22 during the first cleaning process (i.e., the step SD2), the first rinsing process (i.e., the step SD3), the second cleaning process (i.e., the step SD4), or the second rinsing process (i.e., the step SD5), or any combination thereof. For example, the gas pressure in the recovery passageway 19 may be reduced by discharging the gas G from the recovery passageway 19 via the second discharge ports 22, the liquid may be supplied from the space KP1 of the cleaning tool 600T to the recovery passageway 19, and, after a prescribed time has elapsed, the liquid may be discharged from the recovery passageway 19 to the space KP1 of the cleaning tool 600T. In this case, a configuration may be adopted that promotes the supply of the gas G via the second discharge ports 22 and the discharge of the liquid from the recovery passageway 19.

In addition, even if the recovery passageway 19 is not negatively pressurized during the first cleaning process (i.e., the step SD2), the first rinsing process (i.e., the step SD3), the second cleaning process (i.e., the step SD4), or the second rinsing process (i.e., the step SD5), or any combination thereof, the recovery passageway 19 does not have to be negatively pressurized as long as the liquid supplied via the supply ports 64 can be supplied to the recovery passageway 19 via the recovery ports 18.

Furthermore, in the present embodiment, too, the opening 15 may be covered with the cover member of the cleaning tool 600T, and the liquid (i.e., the first cleaning liquid LC1, the second cleaning liquid LC2, or the rinsing liquid LH, or any combination thereof) supplied via the supply ports 64 may be hindered from contacting, for example, the last optical element 8.

After the cleaning apparatus 600 has been unloaded, the dummy substrate DP held by the substrate stage 2P is disposed such that it opposes the liquid immersion member 3. The control apparatus 4 starts the third rinsing process (i.e., the step SD6) in the state wherein the liquid immersion member 3 and the dummy substrate DP are opposed. The present third rinsing process is performed in the same manner as the third rinsing process explained in the first embodiment (i.e., the step SC6) discussed above. A detailed explanation of the third rinsing process is omitted.

The above step completes the cleaning sequence. After the cleaning sequence has ended, the exposure sequence discussed above, for example, may be started.

In the present embodiment, too, as explained above, the liquid immersion member 3 can be cleaned satisfactorily. Accordingly, it is possible to prevent exposure failures from occurring and defective devices from being produced.

In addition, in the present embodiment, too, at least part of the surfaces of the liquid immersion member 3—including the lower surface 14 of the liquid immersion member 3, the surfaces (i.e., the upper surface 28A, the lower surface 28B, or the inner surfaces of the holes 28H, or any combination thereof) of the first member 28, the inner surface of the recovery passageway 19, and the surfaces (i.e., the upper surfaces 27A, the lower surfaces 27B, or the inner surfaces of the holes 27H, or any combination thereof) of the second members 27—can be cleaned satisfactorily.

Furthermore, in the present embodiment, the liquid immersion member 3 may be provided such that a liquid discharge port (i.e., a liquid recovery port) other than the first discharge ports 21 and the second discharge ports 22 faces the recovery passageway 19, and the liquid (i.e., the first cleaning liquid LC1, the second cleaning liquid LC2, or the rinsing liquid LH, or any combination thereof) supplied via the supply ports 64 and then to the recovery passageway 19 via the recovery ports 18 may be discharged (i.e., recovered) via that liquid discharge port.

Furthermore, in the first through third embodiments discussed above, not all of the lower surface 14 of the liquid immersion member 3, the surfaces of the first member 28, the inner surface of the recovery passageway 19, and the surfaces of the second members 27 have to be cleaned. For example, at least part of the second members 27, which have the first discharge ports 21, do not have to be cleaned.

Furthermore, during the cleaning sequence in the first through third embodiments discussed above, the position of the surface (i.e., the liquid level) of the liquid (i.e., the first cleaning liquid LC1, the second cleaning liquid LC2, or the rinsing liquid LH, or any combination thereof) present in the recovery passageway 19 may be moved reciprocatively in the Z axial directions. In other words, the vertical movement of the liquid surface in the recovery passageway 19 may occur repetitively.

For example, performing the fluid discharge operation or the gas supply operation, or both, via the second discharge ports 22 to adjust the pressure in the recovery passageway 19 makes it possible to adjust the position of the surface of the liquid in the recovery passageway 19. For example, stopping the fluid discharge operation via the second discharge ports 22, performing the gas supply operation via the second discharge ports 22, or the like, makes it possible to move the surface of the liquid in the recovery passageway 19 in the −Z direction. In addition, performing the fluid discharge operation via the second discharge ports 22 makes it possible to move the surface of the liquid in the recovery passageway 19 in the +Z direction.

For example, the pressure in the recovery passageway 19 may be adjusted so that the position of the surface of the liquid is disposed below the second members 27 (i.e., the lower surfaces 27B). In addition, the pressure in the recovery passageway 19 may be adjusted so that the position of the surface of the liquid is disposed above the second members 27 (i.e., the lower surfaces 27B). In addition, the pressure in the recovery passageway 19 may be adjusted so that the position of at least part of the surface of the liquid in the recovery passageway 19 is disposed below the first member 28 (i.e., the lower surface 28B). Namely, the pressure in the recovery passageway 19 may be adjusted so that the liquid does not contact to at least part of the first member 28 (i.e., the lower surface 28B).

In addition, the pressure in the recovery passageway 19 may be adjusted so that a first state, wherein at least part of the surface of the liquid is disposed below the first member 28 (i.e., the lower surface 28B), and a second state, wherein such is disposed above the first member 28 (i.e., the upper surface 28A), alternate repetitively. The first state includes the state wherein the liquid does not contact the first member 28, and the second state includes the state wherein the liquid does contact the first member 28.

The pressure in the recovery passageway 19 may be adjusted so that states where the surface of the liquid and the first member 28 are contacted or not, alternate repetitively. The state where the surface of the liquid and the first member 28 are contacted includes a state where at least part of the surface of the liquid and at least part of the first member 28 are contacted, a state where at least part of at least one of the holes 28H of the first member 28 is filled with the liquid, or a state where the entire of all of the holes 28H of the first member 28 is filled with the liquid.

In addition, the pressure in the recovery passageway 19 may be adjusted so that a third state, wherein at least part of the surface of the liquid in the recovery passageway 19 is disposed below the second members 27 (i.e., the lower surfaces 27B), and a fourth state, wherein such is disposed above the second members 27 (i.e., the lower surfaces 27B), alternate repetitively. The third state includes the state wherein the liquid in the recovery passageway 19 does not contact the second members 27, and the fourth state includes the state wherein the liquid in the recovery passageway 19 does contact the second members 27. Furthermore, in the fourth state, the liquid may be supplied via the first discharge ports 21 of the second members 27.

The pressure in the recovery passageway 19 may be adjusted so that states where the surface of the liquid in the recovery passageway 19 and the second member 27 are contacted or not, alternate repetitively. The state where the surface of the liquid in the recovery passageway 19 and the second member 27 are contacted includes a state where at least part of the surface of the liquid in the recovery passageway 19 and at least part of the second member 27 are contacted, a state where at least part of at least one of the holes 27H of the second member 27 is filled with the liquid in the recovery passageway 19, or a state where the entire of all of the holes 27H of the second member 27 is filled with the liquid in the recovery passageway 19.

Furthermore, during at least part of the operation that displaces the surface of the liquid in the recovery passageway 19 in the vertical directions (i.e., the operation that adjusts the pressure in the recovery passageway 19), the supply of that liquid via the first discharge ports 21 may be performed or stopped. For example, when the surface of the liquid in the recovery passageway 19 is being moved downward, the supply of that liquid via the first discharge ports 21 may be performed; furthermore, when the surface of the liquid is being moved upward, the supply of that liquid via the first discharge ports 21 may be stopped. In addition, when the surface of the liquid in the recovery passageway 19 is being moved downward, the supply of that liquid via the first discharge ports 21 may be stopped; furthermore, when the surface of the liquid is being moved upward, the supply of that liquid via the first discharge ports 21 may be performed.

In addition, the position of the surface of the liquid in the recovery passageway 19 can also be adjusted by adjusting the operation that supplies the liquid via the supply ports 64 of the cleaning tool 600T. For example, stopping the supply of the liquid via the supply ports 64, reducing the amount of liquid supplied per unit of time via the supply ports 64, increasing the amount of liquid recovered (i.e., the amount of discharge) per unit of time via the recovery port 65 (i.e., the discharge ports 67), or the like, makes it possible to move the surface of the liquid in the recovery passageway 19 in the −Z direction. In addition, increasing the amount of liquid supplied per unit of time via the supply ports 64, decreasing the amount of liquid recovered (i.e., the amount of discharge) per unit of time via the recovery port 65 (i.e., the discharge ports 67), or the like, makes it possible to move the surface of the liquid in the recovery passageway 19 in the +Z direction.

Fluctuating the position of the surface of the liquid in the recovery passageway 19 makes it possible to deliver the foreign matter eliminated via, for example, the second members 27 together with the liquid to the cleaning tool 600T (i.e., the space KP1). The cleaning tool 600T can recover that foreign matter via the recovery port 65 (i.e., the discharge ports 67). Thereby, the foreign matter eliminated via the second members 27 can be hindered from re-adhering to the second members 27.

Furthermore, in each of the embodiments discussed above, the hindering part (40 and the like), which hinders contact between the second discharge ports 22 and the exposure liquid LQ, is provided, but it does not have to be provided.

Furthermore, in each of the embodiments discussed above, the cleaning sequence is performed using the first cleaning liquid LC1 and the second cleaning liquid LC2; however, the cleaning sequence may be performed using a single cleaning liquid or using three or more cleaning liquids.

Furthermore, in each of the embodiments discussed above, the rinsing processes that are performed after the cleaning processes wherein the cleaning liquids LC are used may be omitted. For example, the first rinsing process may be omitted.

Furthermore, in each of the embodiments discussed above, the cleaning sequence may be supplemented with the cleaning process that uses the ultrasonic wave generating apparatus 13 installed on the measurement stage 2C. For example, at least part of the liquid immersion member 3 and the like may be cleaned by forming the immersion space LS with the exposure liquid LQ between the liquid immersion member 3 and the measurement stage 2C and imparting ultrasonic waves using the ultrasonic wave generating apparatus 13 to the exposure liquid LQ in the immersion space LS.

Furthermore, the third rinsing process (i.e., SC6 or SD6, or both) may be performed above the measurement stage 2C. In this case, the ultrasonic wave generating apparatus 13 may impart ultrasonic waves in parallel therewith.

Furthermore, the ultrasonic wave generating apparatus 13 does not have to be installed on the measurement stage 2C.

Furthermore, in each of the embodiments discussed above, the first member 28 comprises the first portion 281 and the second portion 282, which are provided such that their resistances to the inflow of the gas G are different; however, the first member 28 does not have to be provided with multiple portions that have different resistances to the inflow of the gas G.

Furthermore, in each of the embodiments discussed above, the upper surface 28A or the lower surface 28B, or both, of the first member 28 may be tilted with respect to the horizontal plane (i.e., the XY plane).

Furthermore, in each of the embodiments discussed above, the first discharge ports 21 or the second discharge ports 22, or both, do not have to oppose the upper surface 28A of the first member 28. For example, the first discharge ports 21 or the second discharge ports 22, or both, may be disposed on the outer side of an outer side end part of the first member 28 in the radial directions with respect to the optical path K. Namely, the first discharge ports 21 or the second discharge ports 22, or both, may be disposed farther from the optical path K in the radial directions with respect to the optical path K than the first member 28 is.

Furthermore, in each of the embodiments discussed above, the first discharge ports 21 may be disposed on the inner side of the second discharge ports 22 in radial directions with respect to the optical path K. Namely, the first discharge ports 21 may be nearer to the optical path K than the second discharge ports 22 are.

Furthermore, in each of the embodiments discussed above, the first discharge ports 21 face the −Z direction, but they may face a direction other than the −Z direction. For example, they may face the +Z direction, or a direction parallel to the Y axial directions; furthermore, the third surfaces 27B of the second members 27 may be tilted with respect to the horizontal plane (i.e., the XY plane).

Furthermore, in each of the embodiments discussed above, the second discharge ports 22 face the −Z direction, but they may face a different direction. For example, they may face the +Z direction. Alternatively, they may face a direction parallel to the Y axial directions.

Furthermore, the direction in which the first discharge ports 21 face and the direction in which the second discharge ports 22 face may be different.

Furthermore, in each of the embodiments discussed above, the liquid immersion member 3 may be capable of moving with respect to the last optical element 8. For example, the liquid immersion member 3 may be capable of moving in the Z axial directions with respect to the last optical element 8. In addition, the liquid immersion member 3 may be capable of moving in the θX directions or the θY directions, or both, with respect to the last optical element 8. In other words, the liquid immersion member 3 may be capable of tilting. Of course, the liquid immersion member 3 may be capable of moving in the X axial directions, the Y axial directions, the θZ directions, or any combination thereof, with respect to the last optical element 8. Furthermore, the liquid immersion member 3 may be capable of moving by an actuator, such as a voice coil motor. In addition, the liquid immersion member 3 may be capable of moving by an elastic member that comprises, for example, a spring, or by being supported by a flexible member that comprises, for example, a bellows.

Furthermore, in each of the embodiments discussed above, the “radial directions with respect to the optical path K” may be regarded as the radial directions with respect to the optical axis AX of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and the external apparatus. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the exposure liquid LQ.

The program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, via the first discharge ports 21, the exposure liquid LQ in the recovery passageway 19 of the liquid immersion member 3 wherethrough the exposure liquid LQ from the recovery ports 18 flows; a process that discharges the gas G from the recovery passageway 19 via the second discharge ports 22, which hinder the discharge of the exposure liquid LQ more than the first discharge ports 21 do; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) to the recovery passageway 19; and a process that recovers the cleaning liquids LC (LC1, LC2) from the recovery passageway 19 via the recovery ports 18 and then via the recovery port 65 of the cleaning tool 600T.

In addition, the program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, from the recovery passageway 19 of the liquid immersion member 3 wherethrough the exposure liquid LQ from the recovery ports 18 flows, a fluid that includes the exposure liquid LQ and that has a higher percentage of the exposure liquid LQ than of the gas G via the first discharge ports 21; a process that discharges from the recovery passageway 19 a fluid that includes the gas G and that has a lower percentage of the exposure liquid LQ than of the gas G via the second discharge ports 22; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) to the recovery passageway 19; and a process that recovers the cleaning liquids LC (LC1, LC2) from the recovery passageway 19 via the recovery ports 18 and then via the recovery port 65 of the cleaning tool 600T.

In addition, the program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, via the first discharge ports 21 of the discharge parts 20, which are capable of separately discharging the exposure liquid LQ and the gas G from the recovery passageway 19, the exposure liquid LQ in the recovery passageway 19 of the liquid immersion member 3 wherethrough the exposure liquid LQ from the recovery ports 18 flows; a process that discharges the gas G from the recovery passageway 19 via the second discharge ports 22 of the discharge parts 20; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) to the recovery passageway 19; and a process that recovers the cleaning liquids LC (LC1, LC2) from the recovery passageway 19 via the recovery ports 18 and then via the recovery port 65 of the cleaning tool 600T.

The program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, via the first discharge ports 21, the exposure liquid LQ in the recovery passageway 19 of the liquid immersion member 3 wherethrough the exposure liquid LQ from the recovery ports 18 flows; a process that discharges the gas G from the recovery passageway 19 via the second discharge ports 22, which hinder the discharge of the exposure liquid LQ more than the first discharge ports 21 do; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) via the supply ports 64 of the cleaning tool 600T; and a process that supplies the cleaning liquids LC (LC1, LC2), which were supplied via the supply ports 64, to the recovery passageway 19 via the recovery ports 18.

In addition, the program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, from the recovery passageway 19 of the liquid immersion member 3 wherethrough the exposure liquid LQ from the recovery ports 18 flows, a fluid that includes the exposure liquid LQ and that has a higher percentage of the exposure liquid LQ than of the gas G via the first discharge ports 21; a process that discharges from the recovery passageway 19 a fluid that includes the gas G and that has a lower percentage of the exposure liquid LQ than of the gas G via the second discharge ports 22; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) via the supply ports 64 of the cleaning tool 600T; and a process that supplies the cleaning liquids LC (LC1, LC2), which were supplied via the supply ports 64, to the recovery passageway 19 via the recovery ports 18.

In addition, the program stored in the storage apparatus 5 may cause the control apparatus 4 to execute the following processes according to the embodiments discussed above: a process that forms the immersion space LS with the exposure liquid LQ between the liquid immersion member 3 and the substrate P such that the optical path K of the exposure light EL passing through the exposure liquid LQ between the last optical element 8 and the substrate P is filled with the exposure liquid LQ; a process that exposes the substrate P with the exposure light EL, which transits the exposure liquid LQ in the immersion space LS; a process that recovers at least some of the exposure liquid LQ from the space above the substrate P via the recovery ports 18 of the liquid immersion member 3; a process that discharges, via the first discharge ports 21 of the discharge parts 20, which are capable of separately discharging the exposure liquid LQ and the gas G from the recovery passageway 19, the exposure liquid LQ in the recovery passageway 19 of the liquid immersion member 3 wherethrough the exposure liquid LQ from the recovery ports 18 flows; a process that discharges the gas G from the recovery passageway 19 via the second discharge ports 22 of the discharge parts 20; a process that, when an exposure is not being performed, loads the cleaning tool 600T into the exposure apparatus EX and disposes the cleaning tool 600T at a position at which it opposes the recovery ports 18; a process that supplies the cleaning liquids LC (LC1, LC2) via the supply ports 64 of the cleaning tool 600T; and a process that supplies the cleaning liquids LC (LC1, LC2), which were supplied via the supply ports 64, to the recovery passageway 19 via the recovery ports 18.

The program stored in the storage apparatus 5 is read by the control apparatus 4, and thereby the various processes, such as the immersion exposure of the substrate P in the state wherein the immersion space LS is formed, are executed in cooperation with the various apparatuses of the exposure apparatus EX, such as the substrate stage 2P, the liquid immersion member 3, the liquid supply apparatus 35, the first discharge apparatus 24, and the second discharge apparatus 26.

Furthermore, in each of the embodiments discussed above, the optical path K on the emergent (i.e., the image plane) side of the last optical element 8 of the projection optical system PL is filled with the exposure liquid LQ; however, the projection optical system PL may be a projection optical system wherein the optical path K on the incident (i.e., the object plane) side of the last optical element 8 is also filled with the exposure liquid LQ, as disclosed in, for example, PCT International Publication No. WO2004/019128.

Furthermore, in each of the embodiments discussed above, the exposure liquid LQ is water but may be a liquid other than water. Preferably, the exposure liquid LQ is a liquid that is transparent with respect to the exposure light EL, has a high refractive index with respect to the exposure light EL, and is stable with respect to the projection optical system PL or the film of, for example, the photosensitive material (i.e., the photoresist) that forms the front surface of the substrate P. For example, the exposure liquid LQ may be a fluorine-based liquid such as hydro-fluoro-ether (HFE), perfluorinated polyether (PFPE), or Fomblin® oil. In addition, the exposure liquid LQ may be any of various fluids, for example, a supercritical fluid.

Furthermore, the substrate P in each of the embodiments discussed above is a semiconductor wafer for fabricating semiconductor devices, but it may be, for example, a glass substrate for display devices, a ceramic wafer for thin film magnetic heads, or the original plate of a mask or a reticle (e.g., synthetic quartz or a silicon wafer) used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure apparatus EX may be, for example, a step-and-repeat type projection exposure apparatus (i.e., a stepper), which performs a full field exposure of the pattern of the mask M—with the mask M and the substrate P in a stationary state—and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system PL to transfer a reduced image of a first pattern onto the substrate P in a state wherein the first pattern and the substrate P are substantially stationary, after which the projection optical system PL is used to partially superpose a reduced image of a second pattern onto the transferred first pattern in the state wherein the second pattern and the substrate P are substantially stationary. In addition, the stitching type exposure apparatus may be a step-and-stitch type exposure apparatus that successively transfers at least two patterns onto the substrate P such that they are partially superposed and steps the substrate P.

In addition, the exposure apparatus EX may be an exposure apparatus that combines on the substrate P the patterns of two masks through a projection optical system and double exposes, substantially simultaneously, a single shot region on the substrate P using a single scanning exposure, as disclosed in, for example, U.S. Pat. No. 6,611,316. In addition, the exposure apparatus EX may be a proximity type exposure apparatus, a mirror projection aligner, or the like.

Furthermore, the exposure apparatus EX does not have to comprise the measurement stage 2C.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, if the exposure apparatus EX comprises two of the substrate stages, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or any combination thereof.

In addition, the exposure apparatus EX may be an exposure apparatus that comprises a plurality of the substrate stages and the measurement stages.

The exposure apparatus EX may be a semiconductor device fabrication exposure apparatus that exposes the substrate P with the pattern of a semiconductor device, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks.

Furthermore, in each of the embodiments discussed above, the position of each of the stages (i.e., the mask stage 1, the measurement stage 2C, and the substrate stage 2P) is measured using the interferometer system 130, but the present invention is not limited thereto; for example, an encoder system that detects a scale (i.e., a diffraction grating) provided to each of the stages (i.e., the mask stage 1, the measurement stage 2C, and the substrate stage 2P) may be used, or the interferometer system 130 may be used in parallel with the encoder system.

Furthermore, in the embodiments discussed above, the optically transmissive mask M wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

In each of the embodiments discussed above, the exposure apparatus EX comprises the projection optical system PL; however, the constituent elements explained in each of the embodiments discussed above may be adapted to an exposure apparatus and an exposing method that does not use the projection optical system PL. For example, the constituent elements explained in each of the embodiments discussed above may be adapted to an exposure apparatus and an exposing method wherein the immersion space LS is formed between the substrate P and an optical member such as a lens, and the exposure light EL is radiated to the substrate P via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the connection of mechanical components, the wiring and connection of electrical circuits, and the piping and connection of the pneumatic circuits among the various subsystems. Naturally, prior to performing the process of assembling the exposure apparatus EX from these various subsystems, there are also the processes of assembling each individual subsystem. After the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room, wherein the temperature, the cleanliness level, and the like are controlled.

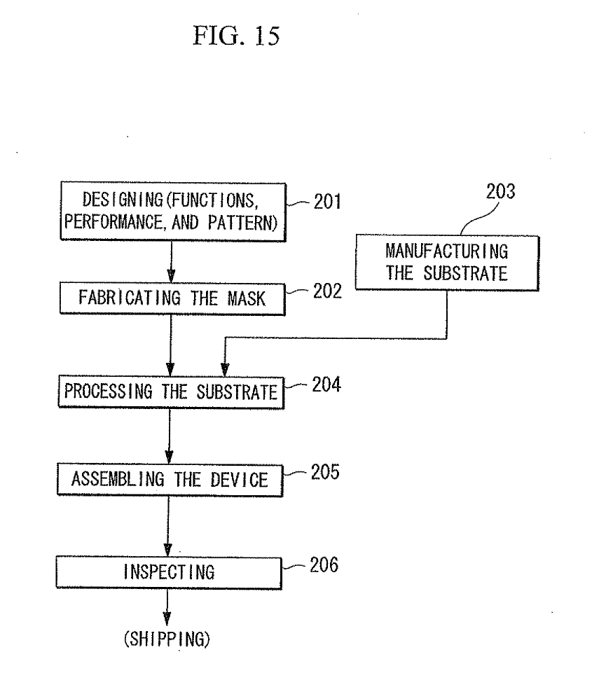

As shown in FIG. 15, a microdevice, such as a semiconductor device, is manufactured by: a step 201 that designs the functions and performance of the microdevice; a step 202 that fabricates the mask M (i.e., the reticle) based on this designing step; a step 203 that manufactures the substrate P, which is the base material of the device; a substrate processing step 204 that comprises a substrate process (i.e., an exposure process) that includes, in accordance with the embodiments discussed above, exposing the substrate P with the exposure light EL that emerges from the pattern of the mask M and developing the exposed substrate P; a device assembling step 205 (which includes fabrication processes such as dicing, bonding, and packaging processes); an inspecting step 206; and the like.

Furthermore, the features of each of the embodiments discussed above can be combined as appropriate. In addition, there are also cases wherein some of the constituent elements are not used. In addition, each disclosure of every Japanese published patent application and U.S. patent related to the exposure apparatus EX recited in each of the embodiments discussed above, the modified examples, and the like is hereby incorporated by reference in its entirety to the extent permitted by the national laws and regulations.

1. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid to a recovery passageway of the liquid immersion member, wherethrough the exposure liquid from the first recovery port flows;
wherein,
the liquid immersion member has a first discharge port, which is for discharging the exposure liquid from the recovery passageway, and a second discharge port, which is for discharging a gas from the recovery passageway and hinders the discharge of the exposure liquid more than the first discharge port does; and
the cleaning liquid is recovered from a recovery part of the cleaning tool via the first recovery port.

2. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid to a recovery passageway of the liquid immersion member, wherethrough the exposure liquid from the first recovery port flows;
wherein,
the liquid immersion member has a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and
the cleaning liquid is recovered from a recovery part of the cleaning tool via the first recovery port.

3. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid to a recovery passageway of the liquid immersion member, wherethrough the exposure liquid from the first recovery port flows;
wherein,
the liquid immersion member comprises a discharge part, which separately discharges the exposure liquid and a gas from the recovery passageway;
the discharge part has a first discharge port, which is for discharging the exposure liquid from the recovery passageway, and a second discharge port, which is for discharging the gas from the recovery passageway; and
the cleaning liquid is recovered from a recovery part of the cleaning tool via the first recovery port.

4. The cleaning method according to claim 1, wherein
the cleaning liquid is supplied to the recovery passageway via the first discharge port.

5. The cleaning method according to claim 1, wherein
the cleaning liquid is supplied to the recovery passageway via a supply port, which faces the recovery passageway.

6. The cleaning method according to claim 1 comprising,
supplying the cleaning liquid via a supply part of the cleaning tool to at least part of the liquid immersion member.

7. The cleaning method according to claim 6, wherein
the cleaning liquid supplied from the supply part of the cleaning tool is supplied to the recovery passageway via the first recovery port.

8. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid from a supply part of the cleaning tool;
wherein,
the liquid immersion member has a first discharge port, which is for discharging the exposure liquid from the recovery passageway, and a second discharge port, which is for discharging a gas from the recovery passageway and hinders the discharge of the exposure liquid more than the first discharge port does; and
the cleaning liquid supplied from the supply part of the cleaning tool is supplied to the recovery passageway via the first recovery port.

9. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid from a supply part of the cleaning tool;
wherein,
the liquid immersion member has a first discharge port, which is for discharging from a recovery passageway a fluid that includes the exposure liquid and that has a higher percentage of the exposure liquid than of a gas, and a second discharge port, which is for discharging from the recovery passageway a fluid that includes the gas and that has a lower percentage of the exposure liquid than of the gas; and
the cleaning liquid supplied from the supply part of the cleaning tool is supplied to the recovery passageway via the first recovery port.

10. A liquid immersion member cleaning method used in an immersion exposure apparatus that exposes a substrate with exposure light that transits an exposure liquid, wherein the liquid immersion member is disposed at least partly around an optical member and an optical path of the exposure light, which passes through the exposure liquid between the optical member and the substrate, comprising:
loading a cleaning tool into the immersion exposure apparatus and disposing the cleaning tool at a position at which it opposes a first recovery port of the liquid immersion member, which is capable of recovering the exposure liquid; and
supplying a cleaning liquid from a supply part of the cleaning tool;
wherein,
the liquid immersion member comprises a discharge part, which separately discharges the exposure liquid and a gas from the recovery passageway; and
the cleaning liquid supplied from a supply part of the cleaning tool is supplied to the recovery passageway via the first recovery port.

11. The cleaning method according to claim 8, further comprising:
supplying the cleaning liquid to the recovery passageway via the first discharge port.

12. The cleaning method according to claim 8, further comprising:
supplying the cleaning liquid via a supply port of the liquid immersion member, which faces the recovery passageway.

13. The cleaning method according to claim 7, wherein
the cleaning liquid supplied from the supply part of the cleaning tool is supplied in the state wherein the recovery passageway has been negatively pressurized.

14. The cleaning method according to claim 1, wherein
inside the immersion exposure apparatus, the cleaning tool is disposed below the liquid immersion member.

15. The cleaning method according to claim 1, further comprising:
recovering via the first discharge port at least some of the cleaning liquid supplied to the recovery passageway.

16. The cleaning method according to claim 1, comprising:
recovering at least some of the cleaning liquid via the first recovery port and then via a second recovery port of the liquid immersion member.

17. The cleaning method according to claim 1, comprising:
recovering at least some of the cleaning liquid via at least part of the liquid immersion member.

18. The cleaning method according to claim 1, comprising:
holding the cleaning liquid between the cleaning tool and the liquid immersion member.

19. The cleaning method according to claim 1, wherein
the first discharge port includes a hole of a porous member.

20. The cleaning method according to claim 1, wherein
the first recovery port includes a hole of a porous member.

21. The cleaning method according to claim 1, comprising:
imparting ultrasonic waves to the cleaning liquid.

22. The cleaning method according to claim 21, wherein
the cleaning liquid whereto the ultrasonic waves have been imparted is supplied to the recovery passageway.

23. The cleaning method according to claim 1, comprising:
cleaning a member, which has the first discharge port, with the cleaning liquid.

24. A device fabricating method, comprising:
cleaning at least part of the liquid immersion member using a cleaning method according to claim 1;
exposing the substrate via the exposure liquid; and
developing the exposed substrate.

25. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a recovery part, which is disposed at least partly in the cleaning tool and is capable of recovering a cleaning liquid;
wherein,
the liquid immersion member has a recovery passageway, wherethrough the exposure liquid from the first recovery port flows, a first discharge port, which is for discharging the exposure liquid from the recovery passageway, and a second discharge port, which is for discharging a gas from the recovery passageway and hinders the discharge of the exposure liquid more than the first discharge port does; and
the recovery part recovers via the first recovery port the cleaning liquid supplied to the recovery passageway.

26. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a recovery part, which is disposed at least partly in the cleaning tool and is capable of recovering a cleaning liquid;
wherein,
the liquid immersion member has a recovery passageway, wherethrough the exposure liquid from the first recovery port flows, a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and
the recovery part recovers via the first recovery port the cleaning liquid supplied to the recovery passageway.

27. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a recovery part, which is disposed at least partly in the cleaning tool and is capable of recovering a cleaning liquid;
wherein,
the liquid immersion member comprises a recovery passageway, wherethrough the exposure liquid from the first recovery port flows, and a discharge part, which separately discharges the exposure liquid and a gas from the recovery passageway;
the discharge part has a first discharge port, which is for discharging the exposure liquid from the recovery passageway, and a second discharge port, which is for discharging the gas from the recovery passageway; and
the recovery part recovers via the first recovery port the cleaning liquid supplied to the recovery passageway.

28. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a supply part, which is disposed at least partly in the cleaning tool and is capable of supplying a cleaning liquid;
wherein,
the liquid immersion member has a recovery passageway, wherethrough the exposure liquid from the first recovery port flows, a first discharge port, which is for discharging the exposure liquid from the recovery passageway, and a second discharge port, which is for discharging a gas from the recovery passageway and hinders the discharge of the exposure liquid more than the first discharge port does; and
the supply part supplies the cleaning liquid to the recovery passageway via the first recovery port.

29. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a supply part, which is disposed at least partly in the cleaning tool and is capable of supplying a cleaning liquid;
wherein,
the liquid immersion member has a recovery passageway, wherethrough the exposure liquid from the first recovery port flows, a first discharge port, which is for discharging from the recovery passageway a fluid that includes the exposure liquid and that has a higher percentage of the exposure liquid than of the gas, and a second discharge port, which is for discharging from the recovery passageway a fluid that includes the gas and that has a lower percentage of the exposure liquid than of the gas; and
the supply part supplies the cleaning liquid to the recovery passageway via the first recovery port.

30. A cleaning apparatus of a liquid immersion member inside an immersion exposure apparatus that exposes a substrate with exposure light that transits an exposure liquid, wherein the liquid immersion member is disposed at least partly around an optical member and an optical path of the exposure light that passes through the exposure liquid between the optical member and the substrate, comprising:
a cleaning tool, which is capable of being loaded into and unloaded from the immersion exposure apparatus and is disposed at a position at which it opposes a first recovery port of the liquid immersion member, which is capable of recovering the exposure liquid; and
a supply part, which is disposed at least partly in the cleaning tool and is capable of supplying a cleaning liquid;
wherein,
the liquid immersion member comprises a recovery passageway, wherethrough the exposure liquid from the first recovery port flows, and a discharge part, which separately discharges the exposure liquid and a gas from the recovery passageway; and
the supply part supplies the cleaning liquid to the recovery passageway via the first recovery port.

31. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, via a first discharge port, the exposure liquid in a recovery passageway of the liquid immersion member wherethrough the exposure liquid from the first recovery port flows;
discharging a gas from the recovery passageway via a second discharge port, which hinders the discharge of the exposure liquid more than the first discharge port does;
when an exposure is not being performed, loading a cleaning tool into the immersion exposure apparatus and disposing the cleaning tool at a position at which it opposes the first recovery port;
supplying a cleaning liquid to the recovery passageway; and
recovering the cleaning liquid from the recovery passageway via the first recovery port and then via a recovery part of the cleaning tool.

32. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, from a recovery passageway of the liquid immersion member wherethrough the exposure liquid from the first recovery port flows, a fluid that includes the exposure liquid and that has a higher percentage of the exposure liquid than of the gas via a first discharge port;
discharging from the recovery passageway a fluid that includes a gas and that has a lower percentage of the exposure liquid than of the gas via a second discharge port;
when an exposure is not being performed, loading a cleaning tool into the immersion exposure apparatus and disposing the cleaning tool at a position at which it opposes the first recovery port;
supplying a cleaning liquid to the recovery passageway; and
recovering the cleaning liquid from the recovery passageway via the first recovery port and then via a recovery part of the cleaning tool.

33. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, via a first discharge port of a discharge part that is capable of separately discharging the exposure liquid and a gas from a recovery passageway, the exposure liquid in the recovery passageway of the liquid immersion member wherethrough the exposure liquid from the first recovery port flows;
discharging the gas from the recovery passageway via a second discharge port of the discharge part;
when an exposure is not being performed, loading a cleaning tool into the immersion exposure apparatus and disposing the cleaning tool at a position at which it opposes the first recovery port;
supplying a cleaning liquid to the recovery passageway; and
recovering the cleaning liquid from the recovery passageway via the first recovery port and then via a recovery part of the cleaning tool.

34. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, via a first discharge port, the exposure liquid in a recovery passageway of the liquid immersion member wherethrough the exposure liquid from the first recovery port flows;
discharging a gas from the recovery passageway via a second discharge port, which hinders the discharge of the exposure liquid more than the first discharge port does;
when an exposure is not being performed, loading a cleaning tool into the immersion exposure apparatus and disposing the cleaning tool at a position at which it opposes the first recovery port;
supplying a cleaning liquid from a supply part of the cleaning tool; and
supplying the cleaning liquid, which was supplied from the supply part, to the recovery passageway via the first recovery port.

35. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, from a recovery passageway of the liquid immersion member wherethrough the exposure liquid from the first recovery port flows, a fluid that includes the exposure liquid and that has a higher percentage of the exposure liquid than of the gas via a first discharge port;
discharging from the recovery passageway a fluid that includes a gas and that has a lower percentage of the exposure liquid than of the gas via a second discharge port;
when an exposure is not being performed, loading a cleaning tool into the immersion exposure apparatus and disposing the cleaning tool at a position at which it opposes the first recovery port;
supplying a cleaning liquid from a supply part of the cleaning tool; and
supplying the cleaning liquid, which was supplied from the supply part, to the recovery passageway via the first recovery port.

36. A program that causes a computer to control an immersion exposure apparatus that exposes a substrate with exposure light that transits an exposure liquid, comprising:
forming an immersion space with the exposure liquid between a liquid immersion member and the substrate such that an optical path of the exposure light passing through the exposure liquid between an optical member and the substrate is filled with the exposure liquid;
exposing the substrate with the exposure light, which transits the exposure liquid in the immersion space;
recovering at least some of the exposure liquid from the space above the substrate via a first recovery port of the liquid immersion member;
discharging, via a first discharge port of a discharge part that is capable of separately discharging the exposure liquid and a gas from a recovery passageway, the exposure liquid in the recovery passageway of the liquid immersion member wherethrough the exposure liquid from the first recovery port flows;
discharging the gas from the recovery passageway via a second discharge port of the discharge part;
when an exposure is not being performed, loading a cleaning tool into the immersion exposure apparatus and disposing the cleaning tool at a position at which it opposes the first recovery port;
supplying a cleaning liquid from a supply part of the cleaning tool; and
supplying the cleaning liquid, which was supplied from the supply part, to the recovery passageway via the first recovery port.

37. A computer readable storage medium whereon a program according to claim 31 is stored.
